(19) United States
(12) Patent Application Publication
(10) Pub. No.: US 2026/0011493 A1
(43) Pub. Date: Jan. 8, 2026

(54) MULTILAYER CERAMIC CAPACITOR

(71) Applicant: Murata Manufacturing Co., Ltd., Nagaokakyo-shi (JP)

(72) Inventor: Keita AKASHI, Nagaokakyo-shi (JP)

(21) Appl. No.: 19/325,830

(22) Filed: Sep. 11, 2025

Related U.S. Application Data
(63) Continuation of application No. PCT/JP2024/010405, filed on Mar. 18, 2024.

(30) Foreign Application Priority Data
Jun. 2, 2023 (JP) 2023-091275

(51) Int. Cl. H01G 4/008; H01G 4/12; H01G 4/232; H01G 4/248; H01G 4/30

(52) U.S. Cl. CPC H01G 4/008; H01G 4/232; H01G 4/248; H01G 4/30; H01G 4/1227; H01G 4/1236

(57) ABSTRACT

A multilayer ceramic capacitor includes a laminate including dielectric layers and internal electrode layers, first and second main surfaces, first and second lateral surfaces, and first and second end surfaces, first and second external electrodes respectively on the first and second end surfaces, and third and fourth external electrodes respectively on the first and second lateral surfaces. The internal electrode layers include a first internal electrode layers connected to the first and second external electrodes, a second internal electrode layer connected to the third and fourth external electrodes, and a first dummy electrode separated from the first internal electrode layer and provided on a same surface as the first internal electrode layer. The first dummy electrode is not exposed from the first and second lateral surfaces, and the first and second end surfaces.

### CROSS REFERENCE TO RELATED APPLICATIONS

This application claims the benefit of priority to Japanese Patent Application No. 2023-091275, filed on Jun. 2, 2023 and is a Continuation application of PCT Application No. PCT/JP2024/010405 filed on Mar. 18, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

As a multilayer ceramic capacitor, for example, a three-terminal capacitor or what is referred to as a multilayer feedthrough capacitor, which is used for noise suppression in electronic devices, is known. In this three-terminal capacitor, a first internal electrode extending to a surface A and a second internal electrode extending to a surface B orthogonal to the surface A are opposed to each other through a dielectric, thus generating capacitance. Such a multilayer capacitor is disclosed, for example, in Japanese Unexamined Patent Application, Publication No. 2013-45808.

However, as shown in the multilayer ceramic capacitor disclosed in Japanese Unexamined Patent Application, Publication No. 2013-45808, there are regions in the lamination direction in which only the first internal electrodes are present, regions in which only the second internal electrodes are present, and regions in which neither the first nor the second internal electrodes are present. In such cases, step differences corresponding to the thickness of the internal electrodes may arise, potentially causing structural defects.

### SUMMARY OF THE INVENTION

Example embodiments of the present invention provide multilayer ceramic capacitors each able to reduce or prevent structural defects in the multilayer ceramic capacitors.

A multilayer ceramic capacitor according to an example embodiment of the present invention includes a multilayer body including a plurality of dielectric layers that are laminated, and a plurality of internal electrode layers laminated on the dielectric layers, a first main surface and a second main surface opposed to each other in a lamination direction, a first lateral surface and a second lateral surface opposed to each other in a width direction orthogonal or substantially orthogonal to the lamination direction, and a first end surface and a second end surface opposed to each other in a length direction orthogonal or substantially orthogonal to both the lamination direction and the width direction, a first external electrode on the first end surface, a second external electrode on the second end surface, a third external electrode on the first lateral surface, and a fourth external electrode on the second lateral surface, in which the plurality of internal electrode layers includes a first internal electrode layer in the plurality of dielectric layers and connected to the first external electrode and the second external electrode, a second internal electrode layer in one or more of the plurality of dielectric layers different from the first internal electrode layer and connected to the third external electrode and the fourth external electrode, a first dummy electrode spaced apart from the first internal electrode layer and provided on a same layer surface as the first internal electrode layer, in which the first dummy electrode is not exposed from the first lateral surface, the second lateral surface, the first end surface, or the second end surface.

In the multilayer ceramic capacitor according to the above-described example embodiment of the present invention includes a first dummy electrode spaced apart from the first internal electrode layer and provided on a same layer surface as the first internal electrode layer, in which the first dummy electrode is not exposed from the first lateral surface, the second lateral surface, the first end surface, or the second end surface. Therefore, it is possible to reduce or prevent structural defects such as delamination due to step differences in thickness between the internal electrode layers in the dielectric layers.

Example embodiments of the present invention provide multilayer ceramic capacitors each able to reduce or prevent structural defects in the multilayer ceramic capacitors.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view showing an example of a multilayer ceramic capacitor (three-terminal multilayer ceramic capacitor) according to an example embodiment of the present invention.

FIG. 2 is a top view showing an example of a multilayer ceramic capacitor according to an example embodiment of the present invention.

FIG. 3 is a front view showing an example of a multilayer ceramic capacitor according to an example embodiment of the present invention.

FIG. 4 is a cross-sectional view taken along the line IV-IV of FIG. 1.

FIG. 5 is a cross-sectional view taken along the line V-V of FIG. 1.

FIG. 6 is a cross-sectional view taken along the line VI-VI of FIG. 4.

FIG. 7 is a cross-sectional view taken along the line VII-VII of FIG. 4.

FIG. 8 is a cross-sectional view showing a modification of the first dummy electrode shown in FIG. 6.

FIG. 9 is a cross-sectional view showing a modification of the second dummy electrode shown in FIG. 7.

FIG. 10 is a schematic cross-sectional view explaining an arrangement of a first dummy electrode used in an Experimental Example.

FIG. 11 is a schematic cross-sectional view explaining an arrangement of a second dummy electrode used in the Experimental Example.

FIG. 12 is a schematic cross-sectional view explaining an example of a method of measuring a widthwise dimension of a dummy electrode in the Experimental Example.

### DETAILED DESCRIPTION OF THE EXAMPLE EMBODIMENTS

Example embodiments of the present invention will be described in detail below with reference to the drawings.

### 1. MULTILAYER CERAMIC CAPACITOR

Multilayer ceramic capacitors (for example, a three-terminal multilayer ceramic capacitor) according to example embodiments of the present invention will be described.

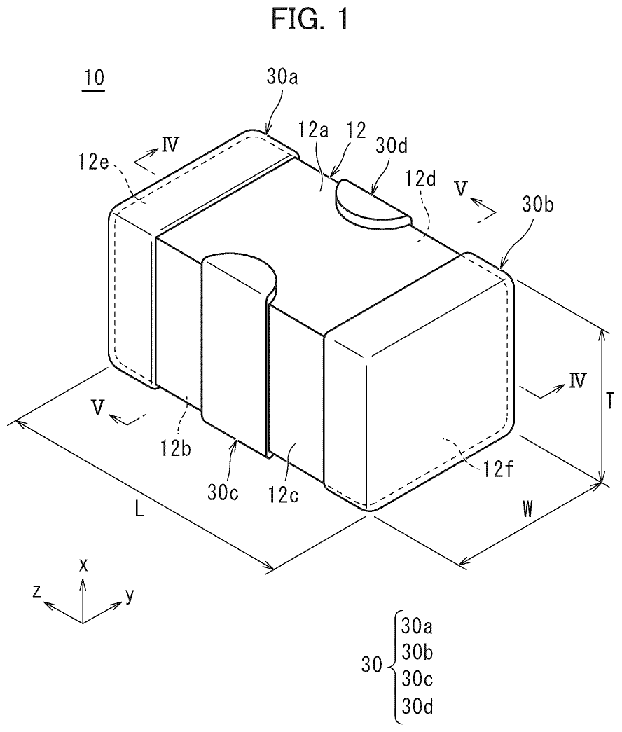

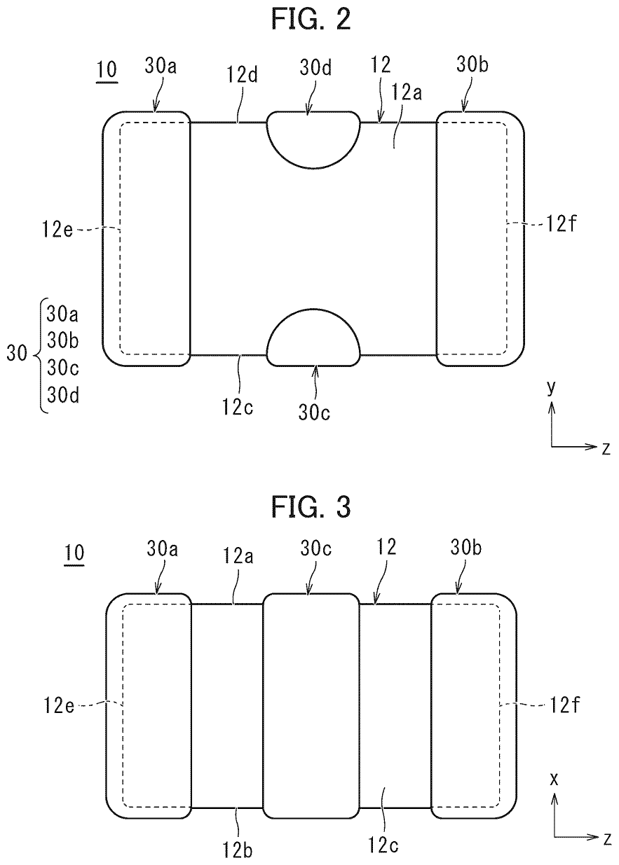

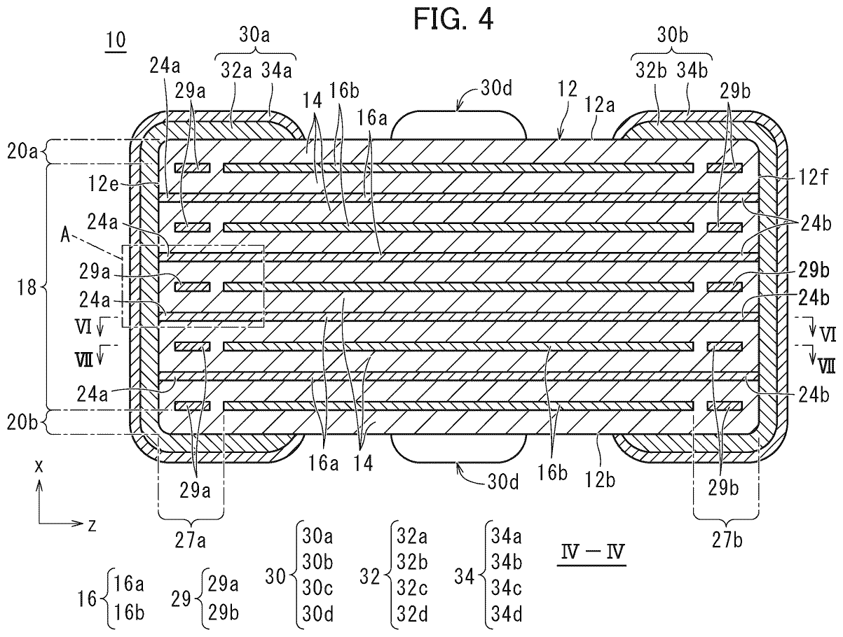

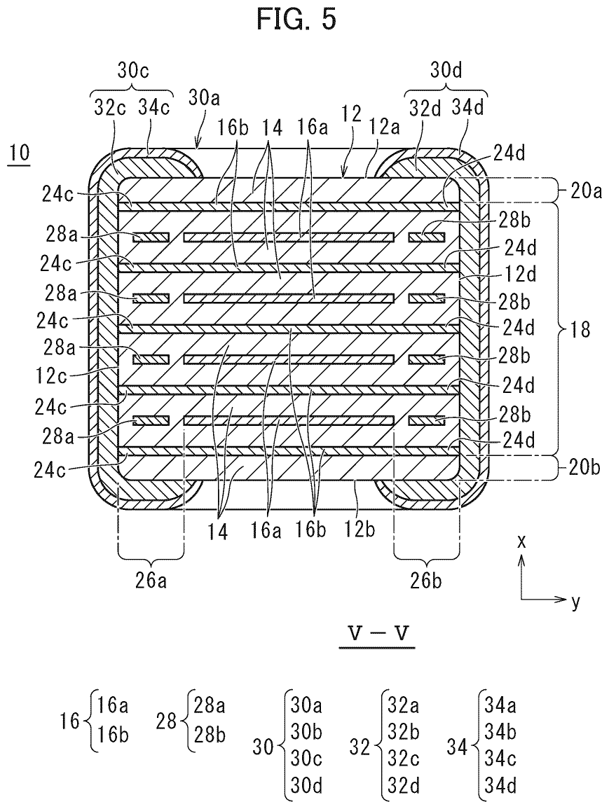

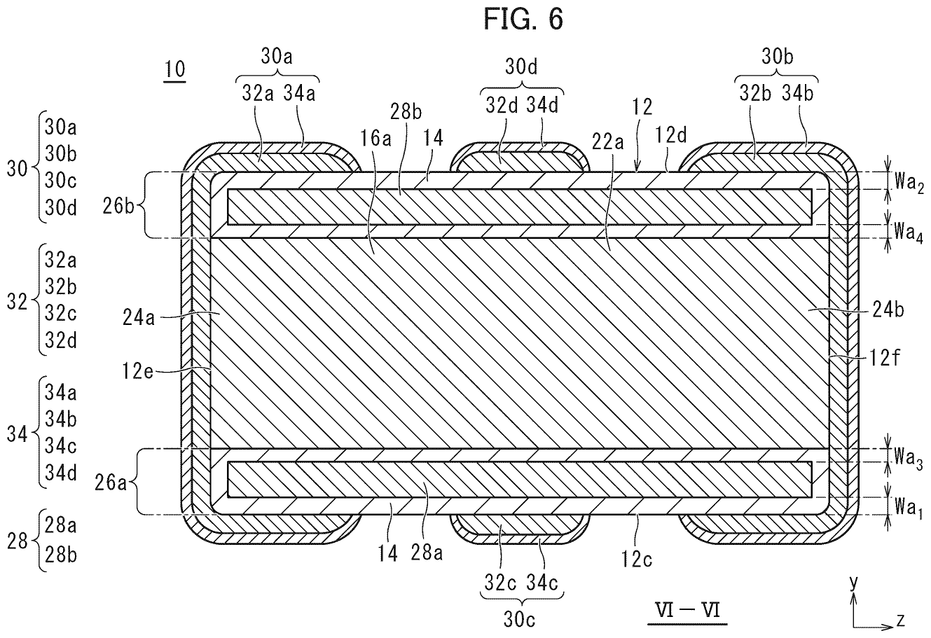

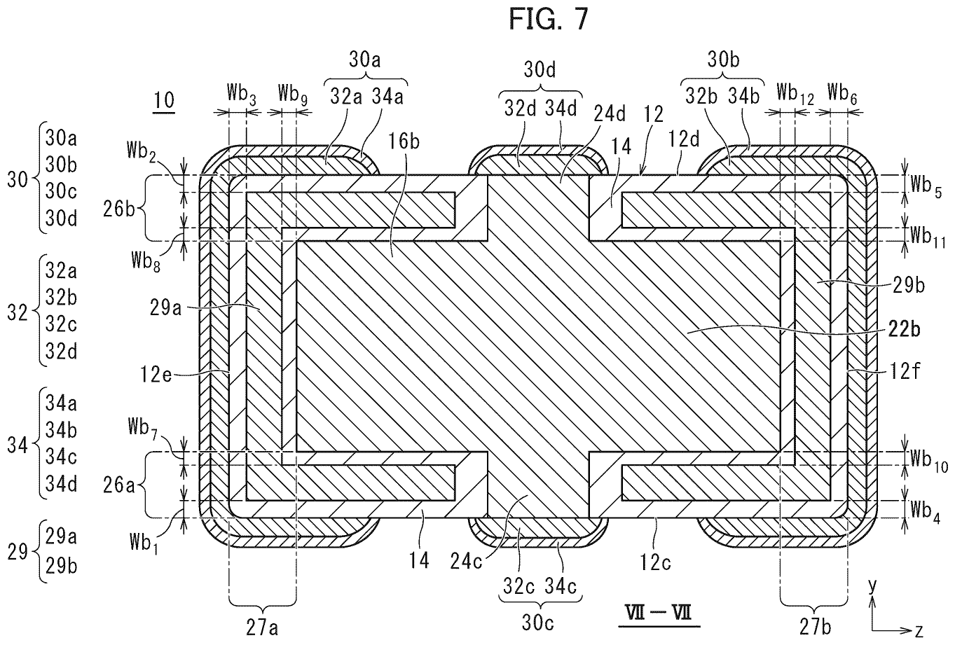

FIG. 1 is an external perspective view showing an example of a multilayer ceramic capacitor (three-terminal multilayer ceramic capacitor) according to an example embodiment of the present invention. FIG. 2 is a top view showing an example of a multilayer ceramic capacitor according to an example embodiment of the present invention. FIG. 3 is a front view showing an example of a multilayer ceramic capacitor according to an example embodiment of the present invention. FIG. 4 is a cross-sectional view taken along the line IV-IV in FIG. 1. FIG. 5 is a cross-sectional view taken along the line V-V in FIG. 1. FIG. 6 is a cross-sectional view taken along the line VI-VI in FIG. 4. FIG. 7 is a cross-sectional view taken along the line VII-VII in FIG. 4.

As shown in FIG. 1, the multilayer ceramic capacitor 10 includes a multilayer body 12 and external electrodes 30.

The multilayer body 12 includes a plurality of laminated dielectric layers 14 and a plurality of internal electrode layers 16 laminated on the dielectric layers 14. The dielectric layers 14 and the internal electrode layers 16 are laminated in a lamination direction x.

The multilayer body 12 has a rectangular or substantially rectangular parallelepiped shape. In addition, the dimension of the multilayer body 12 in the length direction z is not necessarily longer than the dimension thereof in the width direction y. The multilayer body 12 includes a first main surface 12a and a second main surface 12b opposed to each other in the lamination direction x, a first lateral surface 12c and a second lateral surface 12d opposed to each other in the width direction y orthogonal to the lamination direction x, and a first end surface 12e and a second end surface 12f opposed to each other in the length direction z orthogonal to both the lamination direction x and the width direction y.

The multilayer body 12 includes corner portions and ridge portions which are rounded. This rounding prevents chipping and cracking of the multilayer body 12. The term “corner portion” refers to a portion where three adjacent surfaces of the multilayer body intersect, and the term “ridge portion” refers to a portion where two adjacent surfaces of the multilayer body intersect. At least a portion or the entirety of the first main surface 12a, the second main surface 12b, the first lateral surface 12c, the second lateral surface 12d, the first end surface 12e, and the second end surface 12f may include irregularities or surface roughening. The dielectric layers 14 and the internal electrode layers 16 are laminated in the lamination direction x.

As shown in FIGS. 4 and 5, the multilayer body 12 includes an inner layer portion 18 in which a plurality of internal electrode layers 16 opposed to each other in a lamination direction x that connects a first main surface 12a and a second main surface 12b, a first main surface-side outer layer portion 20a including a plurality of dielectric layers 14 provided between the internal electrode layer 16 located closest to the first main surface 12a and the first main surface 12a, and a second main surface-side outer layer portion 20b including a plurality of dielectric layers 14 located between the internal electrode layer 16 located closest to the second main surface 12b and the second main surface 12b.

The first main surface-side outer layer portion 20a is located on the first main surface 12a side of the multilayer body 12, and is a collection of a plurality of dielectric layers 14 located between the first main surface 12a and the internal electrode layer 16 closest to the first main surface 12a.

The second main surface-side outer layer portion 20b is located on the second main surface 12b side of the multilayer body 12, and is a collection of a plurality of dielectric layers 14 located between the second main surface 12b and the internal electrode layer 16 closest to the second main surface 12b.

The region sandwiched between the first main surface-side outer layer portion 20a and the second main surface-side outer layer portion 20b defines the inner layer portion 18.

Although the dimensions of the multilayer body 12 are not particularly limited, it is preferable that the dimension thereof in the length direction z is, for example, between about 0.7 mm and about 3.3 mm inclusive, the dimension thereof in the width direction y is, for example, between about 0.3 mm and about 1.4 mm inclusive, and the dimension thereof in the lamination direction x is, for example, between about 0.2 mm and about 0.7 mm inclusive.

The dielectric layers 14 may be made of, for example, a dielectric material. As such dielectric materials, dielectric ceramics including components such as, for example, BaTiO₃, CaTiO₃, SrTiO₃, or CaZrO₃ may be used. In a case where the dielectric material includes one of the above components as the main component, subcomponents with lower content than the main component, such as, for example, compounds of Mn, Fe, Cr, Co, or Ni may be added depending on the desired characteristics of the multilayer body 12.

It is preferable that the thickness of the dielectric layer 14 after firing is, for example, between about 0.7 μm and about 1.3 μm inclusive. The number of dielectric layers 14 to be laminated is not particularly limited but is, for example, preferably between 200 and 500 inclusive.

The multilayer body 12 includes, as the plurality of internal electrode layers 16, a plurality of first internal electrode layers 16a and a plurality of second internal electrode layers 16b. The plurality of first internal electrode layers 16a and the plurality of second internal electrode layers 16b are embedded alternately at equal or substantially equal intervals along the lamination direction x of the multilayer body 12 with the dielectric layers 14 interposed therebetween.

As shown in FIG. 6, each first internal electrode layer 16a includes a first counter electrode portion 22a opposed to the second internal electrode layer 16b via a dielectric layer 14, a first extension electrode portion 24a extending from the first counter electrode portion 22a to the surface of the first end surface 12e of the multilayer body 12, and a second extension electrode portion 24b extending from the first counter electrode portion 22a to the surface of the second end surface 12f of the multilayer body 12. Specifically, the first extension electrode portion 24a is exposed on the surface of the first end surface 12e of the multilayer body 12, and the second extension electrode portion 24b is exposed on the surface of the second end surface 12f of the multilayer body 12. Accordingly, the first internal electrode layer 16a is not exposed on the surfaces of the first lateral surface 12c or the second lateral surface 12d of the multilayer body 12.

The shapes of the first counter electrode portion 22a and the first extension electrode portion 24a and the second extension electrode portion 24b are not particularly limited, but are preferably rectangular or substantially rectangular. The corners of the first counter electrode portion 22a and the first extension electrode portion 24a and the second extension electrode portion 24b may be rounded.

The length of the first extension electrode portion 24a and the second extension electrode portion 24b in the width direction y may be the same or substantially the same as the length of the first counter electrode portion 22a in the width direction y, or shorter than the length of the first counter electrode portion 22a in the width direction y.

The first extension electrode portion 24a may have a tapered shape in which the length thereof in the width direction y gradually narrows toward the first end surface 12e. The second extension electrode portion 24b may have a tapered shape in which the length thereof in the length direction z gradually narrows toward the second end surface 12f.

As shown in FIG. 7, each second internal electrode layer 16b has a cross shape or substantially a cross shape and includes a second counter electrode portion 22b opposed to the first internal electrode layer 16a via the dielectric layer 14, a third extension electrode portion 24c extending from the second counter electrode portion 22b to the surface of the first lateral surface 12c of the multilayer body 12, and a fourth extension electrode portion 24d extending from the second counter electrode portion 22b to the surface of the second lateral surface 12d of the multilayer body 12. Specifically, the third extension electrode portion 24c is exposed on the surface of the first lateral surface 12c of the multilayer body 12, and the fourth extension electrode portion 24d is exposed on the surface of the second lateral surface 12d of the multilayer body 12. Accordingly, the second internal electrode layer 16b is not exposed on the surfaces of the first end surface 12e and the second end surface 12f of the multilayer body 12.

The shapes of the second counter electrode portion 22b and the third extension electrode portions 24c and the fourth extension electrode portion 24d are not particularly limited, but are preferably rectangular or substantially rectangular. However, the shape of the second counter electrode portion 22b and the corners of the third extension electrode portions 24c and the fourth extension electrode portion 24d may be rounded.

The third extension electrode portion 24c may have a tapered shape in which the length thereof in the length direction z narrows toward the first lateral surface 12c. The fourth extension electrode portion 24d may have a tapered shape in which the length thereof in the length direction z narrows toward the second lateral surface 12d.

The first internal electrode layers 16a and the second internal electrode layers 16b may be alternately laminated with the dielectric layers 14 interposed therebetween. Alternatively, the plurality of dielectric layers 14 including the first internal electrode layers 16a may be laminated first, and the dielectric layers 14 including the second internal electrode layers 16b may be laminated thereafter. In this manner, it is possible to modify the lamination pattern of the internal electrode layers 16 in accordance with the desired capacitance value.

The multilayer body 12 includes a lateral portion (W-gap) 26a located between one end of the first counter electrode portion 22a of the first internal electrode layer 16a and the second counter electrode portion 22b of the second internal electrode layer 16b in the width direction y and the first lateral surface 12c. In addition, the multilayer body 12 includes a lateral portion (W gap) 26b of the multilayer body 12, the lateral portion being located between one end in the width direction y of the first counter electrode portion 22a of the first internal electrode layer 16a and the second counter electrode portion 22b of the second internal electrode layer 16b, and the second lateral surface 12d.

Further, the multilayer body 12 includes a lateral portion (L-gap) 27a of the multilayer body 12, the lateral portion being located between one end in the length direction z of the second counter electrode portion 22b of the second internal electrode layer 16b, and the first end surface 12e. Moreover, the multilayer body 12 includes an end portion (L-gap) 27b located between the other end of the second counter electrode portion 22b of the second internal electrode layer 16b in the length direction z and the second end surface 12f.

The first internal electrode layers 16a and the second internal electrode layers 16b may be made of any appropriate electrically conductive material, such as, for example, a metal including at least one of Ni, Cu, Ag, Pd, or Au, or an alloy including any of those metals, such as an Ag—Pd alloy.

It is preferable that the total number of the first internal electrode layers 16a and the second internal electrode layers 16b is, for example, between 200 and 500 inclusive.

It is preferable that the thickness of each first internal electrode layer 16a is, for example, between about 0.3 μm and about 0.6 μm inclusive. It is preferable that the thickness of each second internal electrode layer 16b is, for example, between about 0.3 μm and about 0.6 μm inclusive.

The inner layer portion 18 of the multilayer body 12 further includes a first dummy electrode 28 and a second dummy electrode 29.

The first dummy electrode 28 includes a first dummy electrode 28a on one side and another first dummy electrode 28b on the other side.

The first dummy electrodes 28a and 28b are alternately laminated with the dielectric layers 14, and are provided on the same plane as the first internal electrode layers 16a provided on the dielectric layers 14. As shown in FIG. 6, each of the first dummy electrodes 28a and 28b is spaced apart from the first internal electrode layer 16a.

The first dummy electrode 28a is provided in a region corresponding to the lateral portion 26a of the multilayer body 12 located on the first lateral surface 12c side. The first dummy electrode 28a is not exposed from the first lateral surface 12c, the second lateral surface 12d, the first end surface 12e, or the second end surface 12f. The first dummy electrode 28b is provided in a region corresponding to the lateral portion 26b of the multilayer body 12 located on the second lateral surface 12d side. The first dummy electrode 28b is not exposed from the first lateral surface 12c, the second lateral surface 12d, the first end surface 12e, or the second end surface 12f.

It is preferable that the distance wa1 between the first dummy electrode 28a and the first lateral surface 12c is, for example, about 1 μm or more. It is preferable that the distance wa2 between the first dummy electrode 28b and the second lateral surface 12d is, for example, about 1 μm or more. With such a configuration, it is possible to reduce or prevent moisture infiltration into the first internal electrode layer 16a. Furthermore, when the distance wa3 between the first dummy electrode 28a and the first internal electrode layer 16a in the width direction y is about 1 μm or more, and the distance wa4 between the first dummy electrode 28b and the first internal electrode layer 16a in the width direction y is about 1 μm or more, it is possible to further reduce or prevent moisture infiltration into the first internal electrode layer 16a.

It is preferable that the length of the first dummy electrode 28a in the width direction y is, for example, between about 68% and about 96% inclusive of the shortest distance from the first internal electrode layer 16a to the first lateral surface 12c. Similarly, it is preferable that the length of the first dummy electrode 28b in the width direction y is, for example, between about 68% and about 96% inclusive of the shortest distance from the first internal electrode layer 16a to the second lateral surface 12d. Within this range, the first dummy electrodes 28a and 28b may be provided discontinuously or intermittently in the width direction y as well.

It is preferable that the length of each of the first dummy electrodes 28a and 28b in the length direction z is, for example, about 50% or more of the overall length of the multilayer body 12 in the length direction z (i.e., the distance connecting the first end surface 12e and the second end surface 12f). The first dummy electrodes 28a and 28b may be arranged discontinuously or intermittently, provided that the length of the first dummy electrodes 28a and 28b is, for example, about 50% or more of the dimension of the multilayer body 12 in the length direction z (i.e., the distance connecting the first end surface 12e and the second end surface 12f).

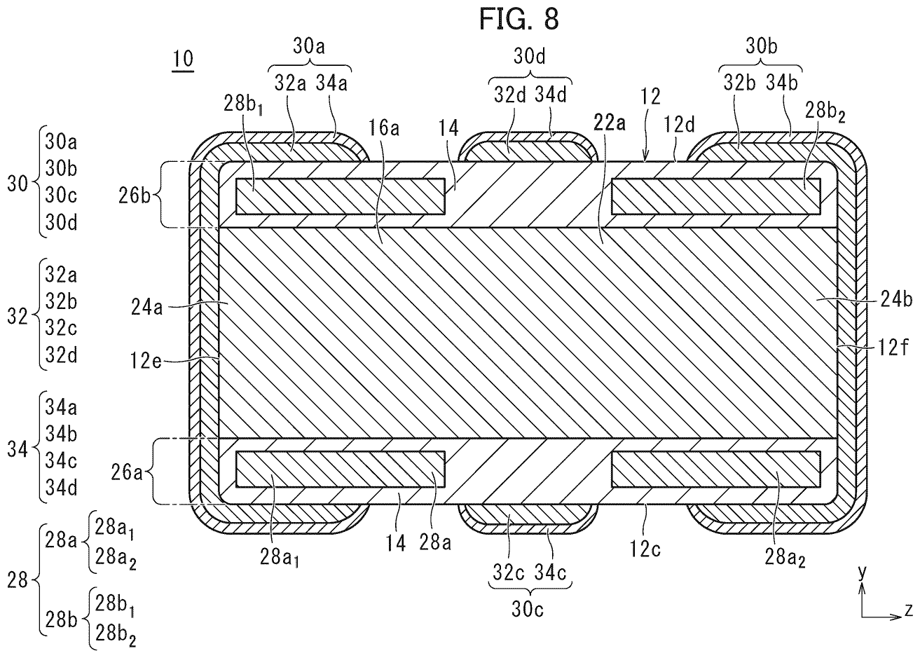

As shown in FIG. 8, the first dummy electrode 28a on one side may be divided into a first dummy electrode 28a1 and a first dummy electrode 28a2. In this case, the first dummy electrode 28a1 is provided in a region corresponding to the lateral portion 26a of the multilayer body 12 located on the first lateral surface 12c side, toward the first end surface 12e side. The first dummy electrode 28a2 is provided in a region corresponding to the lateral portion 26a of the multilayer body 12 located on the first lateral surface 12c side, toward the second end surface 12f side. The first dummy electrodes 28a1 and 28a2 are not exposed from the first lateral surface 12c, the first end surface 12e, or the second end surface 12f.

As shown in FIG. 8, the first dummy electrode 28b on the other side may be further divided into a first dummy electrode 28b1 and a first dummy electrode 28b2. In this case, the first dummy electrode 28b1 is provided in a region corresponding to the lateral portion 26b of the multilayer body 12 located on the second lateral surface 12d side, toward the first end surface 12e side. The first dummy electrode 28b2 is provided in a region corresponding to the lateral portion 26b of the multilayer body 12 located on the second lateral surface 12d side, toward the second end surface 12f side. The first dummy electrodes 28b1 and 28b2 are not exposed from the second lateral surface 12d, the first end surface 12e, or the second end surface 12f.

It is preferable that the total of the length of the first dummy electrode 28a1 in the length direction z and the length of the first dummy electrode 28a2 in the length direction z is, for example, about 50% or more of the dimension of the multilayer body 12 in the length direction z (i.e., the distance connecting the first end surface 12e and the second end surface 12f). Similarly, it is preferable that the total of the length of the first dummy electrode 28b1 in the length direction z and the length of the first dummy electrode 28b2 in the length direction z is, for example, about 50% or more of the dimension of the multilayer body 12 in the length direction z (i.e., the distance connecting the first end surface 12e and the second end surface 12f). As described above, the first dummy electrodes 28a and 28b may be arranged discontinuously or intermittently, provided that the first dummy electrodes 28a and 28b have a length of, for example, about 50% or more of the dimension of the multilayer body 12 in the length direction z (i.e., the distance connecting the first end surface 12e and the second end surface 12f).

It is preferable that the main component of the first dummy electrodes 28a and 28b be the same as that of the first internal electrode layer 16a. For example, when the main component of the first internal electrode layer 16a is Ni, it is preferable that the main component of the first dummy electrodes 28a and 28b is also Ni. When the main component of the first dummy electrodes 28a and 28b is the same as that of the first internal electrode layer 16a, it is possible to reduce or prevent structural defects caused by internal shrinkage differences resulting from concentration variations of the metal component during the firing step when manufacturing the multilayer ceramic capacitor 10.

The second dummy electrode 29 includes a second dummy electrode 29a on one side and a second dummy electrode 29b on the other side.

The second dummy electrodes 29a and 29b are alternately laminated with the dielectric layers 14, and are provided on the same plane as the second internal electrode layers 16b provided on the dielectric layers 14. As shown in FIG. 8, each of the second dummy electrodes 29a and 29b is spaced apart from the second internal electrode layer 16b.

The second dummy electrode 29a is provided toward the first end surface 12e side. Specifically, the second dummy electrode 29a is provided at the end portion 27a of the multilayer body 12 located on the first end surface 12e side, and further extends from the end portion 27a to the lateral portions 26a and 26b of the multilayer body 12. The second dummy electrode 29a is not exposed from the first lateral surface 12c, the second lateral surface 12d, or the first end surface 12e. The second dummy electrode 29b is provided toward the second end surface 12f side. Specifically, the second dummy electrode 29b is provided at the end portion 27b of the multilayer body 12 on the second end surface 12f side, and further extends from the end portion 27b to the lateral portions 26a and 26b. The second dummy electrode 29b is not exposed from the first lateral surface 12c, the second lateral surface 12d, or the first end surface 12e. That is, the second dummy electrode 29a is defined in a region between a region corresponding to a non-extracted region of the second internal electrode layer 16b and the first end surface 12e, the first lateral surface 12c, and the second lateral surface 12d, and the second dummy electrode 29b is defined in a region between a region corresponding to a non-extracted region of the second internal electrode layer 16b and the second end surface 12f, the first lateral surface 12c, and the second lateral surface 12d.

It is preferable that the distance wb1 between the second dummy electrode 29a and the first lateral surface 12c is, for example, about 1 μm or more, the distance wb2 between the second dummy electrode 29a and the second lateral surface 12d is, for example, about 1 μm or more, and the distance wb3 between the second dummy electrode 29a and the first end surface 12e is, for example, about 1 μm or more. It is preferable that the distance wb4 between the second dummy electrode 29b and the first lateral surface 12c is, for example, about 1 μm or more, the distance wb5 between the second dummy electrode 29b and the second lateral surface 12d be 1 μm or more, and the distance wb6 between the second dummy electrode 29b and the second end surface 12f is, for example, about 1 μm or more. With such a configuration, it is possible to reduce or prevent moisture infiltration into the second internal electrode layer 16b. In this case, for example, when the distance wb7 between the second dummy electrode 29a in a region corresponding to the lateral portion 26a of the multilayer body 12 and the second internal electrode layer 16b in the width direction y is about 1 μm or more, the distance wb8 between the second dummy electrode 29a in a region corresponding to the lateral portion 26b of the multilayer body 12 and the second internal electrode layer 16b in the width direction y is about 1 μm or more, and the distance wb9 between the second dummy electrode 29a provided at the end portion 27a of the multilayer body 12 and the second internal electrode layer 16b in the length direction z is about 1 μm or more, it is possible to further reduce or prevent moisture infiltration into the second internal electrode layer 16b. Further, for example, when the distance wb10 between the second dummy electrode 29a provided in a region corresponding to the lateral portion 26 of the multilayer body 12 and the second internal electrode layer 16b in the width direction y is about 1 μm or more, the distance wb11 between the second dummy electrode 29a provided in a region corresponding to the lateral portion 26b of the multilayer body 12 and the second internal electrode layer 16b in the width direction y is about 1 μm or more, and the distance wb12 between the second dummy electrode 29b provided in a region corresponding to the end portion 27b of the multilayer body 12 and the second internal electrode layer 16b in the length direction z is about 1 μm or more, it is possible to further reduce or prevent moisture infiltration into the second internal electrode layer 16b.

It is preferable that the length of the second dummy electrode 29a in the width direction y, in a region corresponding to the lateral portions 26a and 26b of the multilayer body 12, is, for example, between about 70% and about 96% inclusive of the shortest distance from the second internal electrode layer 16b to the first lateral surface 12c. It is preferable that the length of the second dummy electrode 29a in the width direction y, in a region corresponding to the lateral portions 26a and 26b of the multilayer body 12, is, for example, between about 70% and about 96% inclusive of the shortest distance from the second internal electrode layer 16b to the second lateral surface 12d. Within this range, the second dummy electrodes 29a and 29b may be provided discontinuously or intermittently in the width direction y as well.

It is preferable that the length of the second dummy electrode 29a in the length direction z, in a region corresponding to the lateral portions 26a and 26b of the multilayer body 12, is, for example, about 50% or more of the distance from both the extension electrode portions 24c and 24d of the second internal electrode layer 16b to the first end surface 12e. Similarly, it is preferable that the length of the second dummy electrode 29b in the length direction z, in a region corresponding to the lateral portions 26a and 26b of the multilayer body 12, is, for example, about 50% or more of the distance from both the extension electrode portions 24c and 24d of the second internal electrode layer 16b to the second end surface 12f.

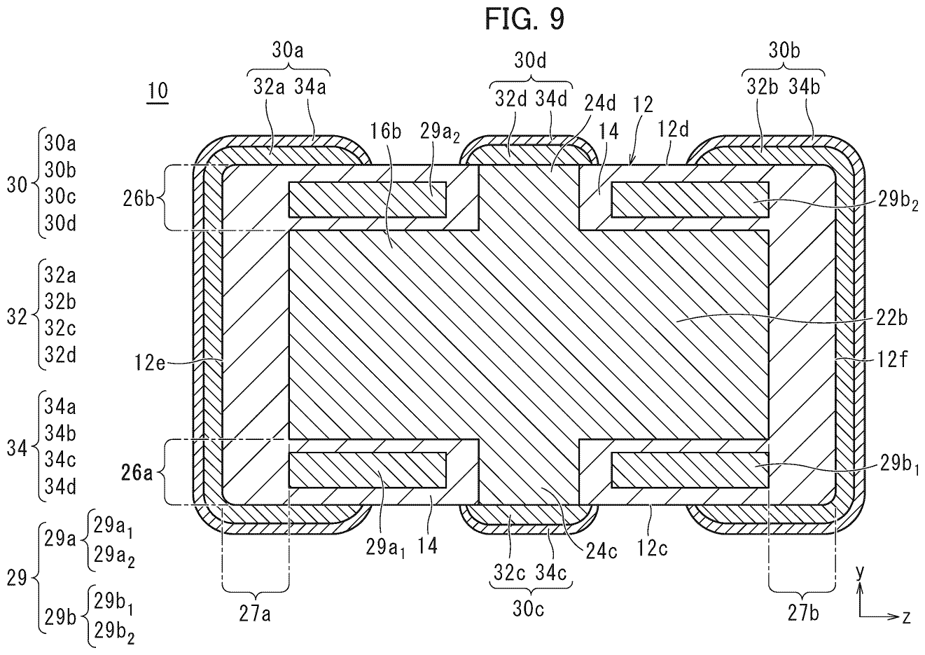

As shown in FIG. 9, the second dummy electrode 29a on one side may be divided into a second dummy electrode 29a1 and a second dummy electrode 29a2. In this case, the second dummy electrode 29a1 is provided in a region corresponding to the lateral portion 26a of the multilayer body 12 located on the first lateral surface 12c side, toward the first end surface 12e side. The second dummy electrode 29a2 is also provided in a region corresponding to the lateral portion 26b of the multilayer body 12 located on the second lateral surface 12d side, toward the first end surface 12e side. The second dummy electrodes 29a1 and 29a2 are not exposed from the first lateral surface 12c, the second lateral surface 12d, or the first end surface 12e.

Similarly, as shown in FIG. 9, the second dummy electrode 29b on one side may be divided into a second dummy electrode 29b1 and a second dummy electrode 29b2. In this case, the second dummy electrode 29b1 is provided in a region corresponding to the lateral portion 26a of the multilayer body 12 located on the first lateral surface 12c side, toward the second end surface 12f side. The second dummy electrode 29b2 is provided in a region corresponding to the lateral portion 26b of the multilayer body 12 located on the second lateral surface 12d side, toward the second end surface 12f side. The second dummy electrodes 29b1 and 29b2 are not exposed from the first lateral surface 12c, the second lateral surface 12d, or the second end surface 12f.

It is preferable that the length of the second dummy electrode 29a1 in the length direction z in a region corresponding to the lateral portion 26a of the multilayer body 12, and the length of the second dummy electrode 29a2 in the length direction z in a region corresponding to the lateral portion 26b of the multilayer body 12, is, for example, about 50% or more of the distance from both the extension electrode portions 24c and 24d of the second internal electrode layer 16b to the first end surface 12e. Similarly, it is preferable that the length of the second dummy electrode 29b1 in the length direction z in a region corresponding to the lateral portion 26a of the multilayer body 12, and the length of the second dummy electrode 29b2 in the length direction z in a region corresponding to the lateral portion 26b of the multilayer body 12, is, for example, about 50% or more of the distance from both the extension electrode portions 24c and 24d of the second internal electrode layer 16b to the second end surface 12f. Thus, the second dummy electrodes 29a and 29b may be provided either continuously or discontinuously/intermittently.

It is preferable that the main component of the second dummy electrodes 29a and 29b is the same as that of the second internal electrode layer 16b. For example, when the main component of the second internal electrode layer 16b is Ni, it is preferable that the main component of the second dummy electrodes 29a and 29b is also Ni. When the main component of the second dummy electrodes 29a and 29b is the same as that of the second internal electrode layer 16b, it is possible to reduce or prevent structural defects caused by internal shrinkage differences due to variations in metal component concentration during the firing step of the multilayer ceramic capacitor 10.

It is preferable that the thickness of the first dummy electrodes 28a and 28b in the lamination direction is equal or approximately equal to the thickness of the first internal electrode layer 16a in the lamination direction. It is preferable that the thickness of the second dummy electrodes 29a and 29b in the lamination direction is equal or approximately equal to the thickness of the second internal electrode layer 16b in the lamination direction. Here, “approximately equal” means that the thickness of the first dummy electrode 28 and the second dummy electrode 29 in the lamination direction is, for example, between about 83% and about 120% inclusive of the thickness of the internal electrode layer 16 in the lamination direction. With such a configuration, it is possible to eliminate the step difference caused by the thickness of the first internal electrode layer 16a and the second internal electrode layer 16b. Accordingly, it is possible to reduce or prevent structural defects due to delamination between dielectric layers 14 in the multilayer body 12.

In the inner layer portion 18, only the first dummy electrode 28 may be provided, or only the second dummy electrode 29 may be provided.

The thickness in the lamination direction of the first dummy electrode 28 and the second dummy electrode 29 is measured by, for example, the method described below. That is, a cross-sectional polishing is performed along the width direction y or the length direction z of the multilayer body 12 up to a portion where the first dummy electrode 28 or the second dummy electrode 29 is exposed. The cross-section obtained by cross-sectional polishing is observed using, for example, a scanning electron microscope (SEM) manufactured by JEOL Ltd. At this time, the magnification is set to about 9000× or below, and a secondary electron image is used. The magnification and field of view of the SEM are set to allow for confirming six layers of the first dummy electrode 28 or the second dummy electrode 29 and five layers of the dielectric layer 14. Thereafter, an average thickness of six layers is calculated in a central region of each of three regions obtained by equally dividing, in the lamination direction, a region in which the first dummy electrode 28 or the second dummy electrode 29 is present (that is, equally dividing the region into three portions in the width direction y or the length direction z). At this time, it is possible to calculate the thickness of the first dummy electrode 28 or the second dummy electrode 29 in the lamination direction by enlarging an SEM image (secondary electron image) obtained by SEM and plotting on each layer.

The external electrodes 30 are provided on the first end surface 12e side and the second end surface 12f side, as well as on the first lateral surface 12c side and the second lateral surface 12d side of the multilayer body 12.

The external electrodes 30 include a base electrode layer 32. It is preferable that the surface of the base electrode layer 32 includes a plated layer 34 provided so as to cover the base electrode layer 32.

The external electrodes 30 include a first external electrode 30a, a second external electrode 30b, a third external electrode 30c, and a fourth external electrode 30d.

The first external electrode 30a is connected to the first internal electrode layer 16a and is provided on the surface of the first end surface 12e. In addition, the first external electrode 30a extends from the first end surface 12e of the multilayer body 12, and is provided on a portion of the first main surface 12a and the second main surface 12b, as well as on a portion of the first lateral surface 12c and the second lateral surface 12d. In this case, the first external electrode 30a is electrically connected to the first extension electrode portion 24a of the first internal electrode layer 16a.

The second external electrode 30b is connected to the first internal electrode layer 16a and is provided on the surface of the second end surface 12f. In addition, the second external electrode 30b extends from the second end surface 12f of the multilayer body 12, and is provided on a portion of the first main surface 12a and the second main surface 12b, as well as on a portion of the first lateral surface 12c and the second lateral surface 12d. In this case, the second external electrode 30b is electrically connected to the second extension electrode portion 24b of the first internal electrode layer 16a.

The third external electrode 30c is connected to the second internal electrode layer 16b and is provided on the surface of the first lateral surface 12c. In addition, the third external electrode 30c extends from the first lateral surface 12c of the multilayer body 12, and is provided on a portion of the first main surface 12a and the second main surface 12b. In this case, the third external electrode 30c is electrically connected to the third extension electrode portion 24c of the second internal electrode layer 16b.

The fourth external electrode 30d is connected to the second internal electrode layer 16b and is provided on the surface of the second lateral surface 12d. In addition, the fourth external electrode 30d extends from the second lateral surface 12d of the multilayer body 12, and is provided on a portion of the first main surface 12a and the second main surface 12b. In this case, the fourth external electrode 30d is electrically connected to the fourth extension electrode portion 24d of the second internal electrode layer 16b.

Inside the multilayer body 12, the first counter electrode portion 22a of the first internal electrode layer 16a and the second counter electrode portion 22b of the second internal electrode layer 16b are opposed to each other via the dielectric layer 14, thus generating capacitance. Therefore, it is possible to generate capacitance between the first external electrode 30a and the second external electrode 30b, which are connected to the first internal electrode layer 16a, and the third external electrode 30c and the fourth external electrode 30d, which are connected to the second internal electrode layer 16b, such that capacitor characteristics are provided.

The base electrode layer 32 includes, for example, at least one of a fired layer, an electrically conductive resin layer, a thin film layer, or the like. The following describes each configuration in a case where the base electrode layer 32 includes a fired layer, an electrically conductive resin layer, or a thin film layer.

The base electrode layer 32 includes a first base electrode layer 32a, a second base electrode layer 32b, a third base electrode layer 32c, and a fourth base electrode layer 32d.

The first base electrode layer 32a is connected to the first internal electrode layer 16a and is provided on the surface of the first end surface 12e. In addition, the first base electrode layer 32a extends from the first end surface 12e and is provided on a portion of the first main surface 12a and the second main surface 12b, as well as on a portion of the first lateral surface 12c and the second lateral surface 12d. In this case, the first base electrode layer 32a is electrically connected to the first extension electrode portion 24a of the first internal electrode layer 16a. The second base electrode layer 32b is connected to the first internal electrode layer 16a and is provided on the surface of the second end surface 12f. In addition, the second base electrode layer 32b extends from the second end surface 12f and is provided on a portion of the first main surface 12a and the second main surface 12b, as well as on a portion of the first lateral surface 12c and the second lateral surface 12d. In this case, the second base electrode layer 32b is electrically connected to the second extension electrode portion 24b of the first internal electrode layer 16a.

The third base electrode layer 32c is connected to the second internal electrode layer 16b and is provided on the surface of the first lateral surface 12c. The third base electrode layer 32c also extends from the first lateral surface 12c to be provided on a portion of the first main surface 12a and a portion of the second main surface 12b. In this case, the third base electrode layer 32c is electrically connected to the third extension electrode portion 24c of the second internal electrode layer 16b. The fourth base electrode layer 32d is connected to the second internal electrode layer 16b and is provided on the surface of the second lateral surface 12d. The fourth base electrode layer 32d also extends from the second lateral surface 12d to be provided on a portion of the first main surface 12a and a portion of the second main surface 12b. In this case, the fourth base electrode layer 32d is electrically connected to the fourth extension electrode portion 24d of the second internal electrode layer 16b.

### Case of Fired Layer

The fired layer includes a glass component and a metal component. The glass component in the fired layer includes, for example, at least one of B, Si, Ba, Mg, Al, Li, or the like. The metal component in the fired layer includes, for example, at least one of Cu, Ni, Ag, Pd, Ag—Pd alloys, Au, or the like. The fired layer may include a plurality of layers. The fired layer is formed by applying an electrically conductive paste including a glass component and a metal component to the multilayer body 12, followed by firing. The fired layer may be formed by simultaneously firing a multilayer chip including the internal electrode layer 16 and the dielectric layer 14 and an electrically conductive paste applied to the multilayer chip, or may be formed by firing the multilayer chip including the internal electrode layer 16 and the dielectric layer 14 to obtain the multilayer body 12, and then applying an electrically conductive paste to the multilayer body 12, followed by firing. In a case where the fired layer is formed by simultaneously firing a multilayer chip including the internal electrode layer 16 and the dielectric layer 14 and an electrically conductive paste applied to the multilayer chip, it is preferable that the fired layer be formed by firing a material in which a dielectric material is added, instead of a glass component.

It is preferable that the thickness in the length direction z, the thickness being measured at a central portion in the lamination direction x of the first base electrode layer 32a provided on the first end surface 12e and extending between the first end surface 12e and the second end surface 12f, is, for example, between about 3 μm and about 70 μm inclusive. It is preferable that the thickness in the length direction z, the thickness being measured at a central portion in the lamination direction x of the second base electrode layer 32b provided on the second end surface 12f and extending between the first end surface 12e and the second end surface 12f, is, for example, between about 3 μm and about 70 μm inclusive. It is preferable that the thickness in the width direction y, the thickness being measured at a central portion in the lamination direction x of the third base electrode layer 32c provided on the first lateral surface 12c and extending between the first lateral surface 12c and the second lateral surface 12d, is, for example, between about 3 μm and about 70 μm inclusive. It is preferable that the thickness in the width direction y, the thickness being measured at a central portion in the lamination direction x of the fourth base electrode layer 32d provided on the second lateral surface 12d and extending between the first lateral surface 12c and the second lateral surface 12d, is, for example, between about 3 μm and about 70 μm inclusive.

It is preferable that the thickness in the lamination direction x connecting the first main surface 12a and the second main surface 12b in the central portion in the length direction z connecting the first end surface 12e and the second end surface 12f of the first base electrode layer 32a located on a portion of the first main surface 12a and the second main surface 12b is, for example, between about 3 μm and about 40 μm inclusive. It is preferable that the thickness in the lamination direction x connecting the first main surface 12a and the second main surface 12b in the central portion in the length direction z connecting the first end surface 12e and the second end surface 12f of the second base electrode layer 32b located on a portion of the first main surface 12a and the second main surface 12b is, for example, between about 3 μm and about 40 μm inclusive. It is preferable that the thickness in the lamination direction x connecting the first main surface 12a and the second main surface 12b in the central portion in the width direction y connecting the first lateral surface 12c and the second lateral surface 12d of the third base electrode layer 32c located on a portion of the first main surface 12a and the second main surface 12b is, for example, between about 3 μm and about 40 μm inclusive. It is preferable that the thickness in the lamination direction x connecting the first main surface 12a and the second main surface 12b in the central portion in the width direction y connecting the first lateral surface 12c and the second lateral surface 12d of the fourth base electrode layer 32d located on a portion of the first main surface 12a and the second main surface 12b is, for example, between about 3 μm and about 40 μm inclusive.

It is preferable that the thickness in the width direction y connecting the first lateral surface 12c and the second lateral surface 12d in the central portion in the length direction z connecting the first end surface 12e and the second end surface 12f of the first base electrode layer 32a located on a portion of the first lateral surface 12c and the second lateral surface 12d is, for example, between about 3 μm and about 40 μm inclusive. It is preferable that the thickness in the width direction y connecting the first lateral surface 12c and the second lateral surface 12d in the central portion in the length direction z connecting the first end surface 12e and the second end surface 12f of the second base electrode layer 32b located on a portion of the first lateral surface 12c and the second lateral surface 12d is, for example, between about 3 μm and about 40 μm inclusive.

### Case of Electrically Conductive Resin Layer

In a case where the electrically conductive resin layer is provided as the base electrode layer 32, the electrically conductive resin layer is provided on the fired layer so as to cover the fired layer. The electrically conductive resin layer includes, for example, a metal and a thermosetting resin. The electrically conductive resin layer may entirely cover the base electrode layer or partially cover the base electrode layer.

Since the electrically conductive resin layer includes a thermosetting resin, the electrically conductive resin layer is, for example, more flexible than an electrically conductive layer made of a plating film or a fired body of an electrically conductive paste. Therefore, even in a case where physical impact or thermal shock due to a temperature cycle is applied to the feedthrough-type multilayer ceramic capacitor 10, the electrically conductive resin layer defines and functions as a buffer layer, thus preventing cracking in the feedthrough-type multilayer ceramic capacitor 10.

As the metal included in the electrically conductive resin layer, for example, Ag, Cu, Ni, Sn, Bi, or an alloy including any of these metals may be used. It is also possible to use metal powder including an Ag coating on the surface of the metal powder. When using metal powder including an Ag coating on the surface of the metal powder, it is preferable to use, for example, Cu, Ni, Sn, Bi, or an alloy powder thereof as the metal powder. The reason for using Ag electrically conductive metal powder as the electrically conductive metal is that Ag is suitable as an electrode material since Ag has the lowest specific resistance among metals, and that Ag does not oxidize and has excellent weather resistance since Ag is a noble metal. This is also because it is possible to maintain the above characteristics of Ag while making the base metal less expensive.

Furthermore, as the metal included in the electrically conductive resin layer, it is also possible to use, for example, Cu or Ni that has been subjected to oxidation-resistant treatment. As the metal included in the electrically conductive resin layer, it is also possible to use metal powder including, for example, Sn, Ni, or Cu coating on the surface of the metal powder. When using metal powder including Sn, Ni, or Cu coating on the surface, it is preferable to use, for example, Ag, Cu, Ni, Sn, Bi, or an alloy powder thereof as the metal powder.

The metal included in the electrically conductive resin layer is mainly responsible for the electrical conductivity of the electrically conductive resin layer. Specifically, an electrical conduction path is provided inside the electrically conductive resin layer by contact between electrically conductive fillers.

The metal included in the electrically conductive resin layer may be in the form of spherical or flake-shaped particles. However, it is preferable to use a mixture of spherical metal powder and flake-shaped metal powder.

As the resin for the electrically conductive resin layer, it is possible to use various known thermosetting resins, such as, for example, epoxy resin, phenolic resin, urethane resin, silicone resin, or polyimide resin. One of the more suitable resins is epoxy resin, which has excellent heat resistance, moisture resistance, and adhesion.

It is also preferable that the electrically conductive resin layer includes a curing agent together with a thermosetting resin. As the curing agent, in a case where an epoxy resin is used as the base resin, it is possible to use various known compounds, such as, for example, phenol-based compounds, amine-based compounds, acid anhydride-based compounds, imidazole-based compounds, active ester-based compounds, or amide-imide-based compounds, as the curing agents for the epoxy resin.

The electrically conductive resin layer may include a plurality of layers.

It is preferable that the thickness of the electrically conductive resin layer, located at the center in the lamination direction x of the multilayer body 12 positioned at the first end surface 12e and the second end surface 12f, is, for example, between about 10 μm and about 150 μm inclusive.

### Case of Thin Film Layer

The base electrode layer 32 may be provided as a thin film layer on the surface of the multilayer body 12. In a case where a thin film layer is provided as the base electrode layer 32, the thin film layer is formed by a thin film forming method such as sputtering or vapor deposition, for example, and is a layer with a thickness of, for example, about 1 μm or less in which metal particles are deposited.

### Plated Layer

The plated layer 34 includes a first plated layer 34a covering the first base electrode layer 32a, a second plated layer 34b covering the second base electrode layer 32b, a third plated layer 34c covering the third base electrode layer 32c, and a fourth plated layer 34d covering the fourth base electrode layer 32d.

The plated layer 34 includes, for example, at least one of Cu, Ni, Sn, Ag, Pd, Ag—Pd alloy, Au, or the like.

The plated layer 34 may include a plurality of layers. It is preferable that the plated layer 34 include a two-layer structure, in which, for example, a Ni plating layer and an Sn plating layer are provided in this order. The Ni plated layer can prevent the base electrode layer 32 from being eroded by solder when the multilayer ceramic capacitor 10 is mounted. The Sn plated layer improves the solder wettability when mounting the multilayer ceramic capacitor 10, and allows easy mounting.

It is preferable that the thickness of each layer of the plated layer 34 is, for example, between about 4 μm and about 10 μm inclusive.

Either or both of the third external electrode 30c and the fourth external electrode 30d may include the plated layer 34 directly provided on the surface of the multilayer body 12. That is, the multilayer ceramic capacitor 10 may be configured to include the plated layer 34 that is directly and electrically connected to the second internal electrode layer 16b. In such cases, the plated layer 34 may be directly provided after a catalyst is provided on the surface of the multilayer body 12 in a pretreatment.

In a case where the plated layer 34 is directly provided on the multilayer body 12, it is preferable that the plated layer 34 include a lower plated electrode on a surface of the multilayer body 12 and an upper plated electrode on a surface of the lower plated electrode.

It is preferable that each of the lower plated electrode and the upper plated electrode include at least one of, for example, Cu, Ni, Sn, Pb, Au, Ag, Pd, Bi, or Zn, or an alloy including the metal.

For example, in a case where the first internal electrode layer 16a and the second internal electrode layer 16b are made using Ni, it is preferable to make the lower plated electrode using Cu, which has good bondability with Ni. In addition, the upper plated electrode may be provided as needed, and particularly, the third external electrode 30c and the fourth external electrode 30d may each include only a lower plated electrode.

In a case where the plated layer 34 is directly provided on the multilayer body 12, the upper plated electrode may define and function as the outermost layer of the plated layer 34, or an additional plated electrode may be provided on the surface of the upper plated electrode.

In a case where the plated layer 34 is directly provided on the multilayer body 12, it is preferable that the thickness of each layer of the plated layer 34 is, for example, between about 1 μm and about 15 μm inclusive.

In a case where the plated layer 34 is directly provided on the multilayer body 12, it is preferable that the plated layer 34 does not include glass. In addition, it is preferable that the metal content per unit volume of the plated layer 34 is, for example, about 99 vol % or more.

The external electrodes 30 may include solely the plated layer, without providing a base electrode layer 32. The following describes a structure in which the plated layer is provided without a base electrode layer 32, although not shown in the drawings.

Either or each of the first external electrode 30a to the fourth external electrode 30d may be provided such that the plated layer is directly provided on the surface of the multilayer body 12 without providing the base electrode layer 32. That is, the multilayer ceramic capacitor 10 may have a structure including a plated layer electrically connected to the first internal electrode layer 16a and the second internal electrode layer 16b. In such cases, the plated layer may be formed after a catalyst is applied to the surface of the multilayer body 12 in a pretreatment.

In a case where the plated layer is directly provided on the multilayer body 12 without providing the base electrode layer 32, the reduction in the thickness of the base electrode layer 32 can be converted into a reduction in profile, that is, thinning, or into an increase in the thickness of the multilayer body 12, that is, the thickness of the inner layer portion 18, such that it is possible to improve the design flexibility of a low-profile chip.

It is preferable that the plated layer includes a lower plated electrode provided on a surface of the multilayer body 12 and an upper plated electrode provided on a surface of the lower plated electrode. It is preferable that each of the lower plated electrode and the upper plated electrode includes at least one of, for example, Cu, Ni, Sn, Pb, Au, Ag, Pd, Bi, or Zn, or an alloy including the metal. Furthermore, it is preferable that the lower plated electrode is formed using Ni having solder barrier performance, and the upper plated electrode is formed using Sn or Au having good solder wettability.

In addition, for example, in a case where the first internal electrode layer 16a and the second internal electrode layer 16b are formed using Ni, it is preferable that the lower plated electrode is formed using Cu, which easily forms an alloy layer with Ni. With such a configuration, an alloy layer of Ni and Cu makes it less likely to generate a gap between the internal electrode layer 16 and the lower plated electrode, thus achieving an advantageous effect of more effectively preventing moisture infiltration.

In addition, the upper plated electrode may be provided as needed, and each of the first to fourth external electrodes 30a to 30d may include a lower plated electrode. The plated layer may include the upper plated electrode as the outermost layer, or another plated electrode may be further provided on the surface of the upper plated electrode.

Here, when the external electrode 30 includes solely a plated layer without providing the base electrode layer 32, it is preferable that the thickness of each layer of the plated layer without providing the base electrode layer 32 is, for example, between about 1 μm and about 15 μm inclusive.

Furthermore, it is preferable that the plated layer does not include glass. It is also preferable that a metal content per unit volume of the plated layer is, for example, about 99 vol % or more.

The dimension in the length direction z of the multilayer ceramic capacitor 10 including the multilayer body 12, the first external electrode 30a, and the second external electrode 30b is defined as the L dimension, the dimension in the lamination direction x of the multilayer ceramic capacitor 10 including the multilayer body 12, the first external electrode 30a, and the second external electrode 30b is defined as the T dimension, and the dimension in the width direction y of the multilayer ceramic capacitor 10 including the multilayer body 12, the first external electrode 30a, and the second external electrode 30b is defined as the W dimension. As the dimensions of the multilayer ceramic capacitor 10, it is preferable that the L dimension in the length direction z is, for example, between about 0.8 mm and about 3.4 mm inclusive, the W dimension in the width direction y is, for example, between about 0.4 mm and about 1.5 mm inclusive, and the T dimension in the lamination direction x is, for example, between about 0.3 mm and about 0.8 mm inclusive.

### 2. METHOD OF MANUFACTURING MULTILAYER CERAMIC CAPACITOR

Next, an example embodiment of a method of manufacturing a multilayer ceramic capacitor will be described.

First, a dielectric sheet for dielectric layers and an electrically conductive paste for internal electrode layers are prepared. The dielectric sheet and the electrically conductive paste for internal electrode layers include a binder and a solvent. The binder and the solvent may be of known types.

Then, the electrically conductive paste for internal electrode layers and the electrically conductive paste for dummy electrodes are printed in a predetermined pattern on the dielectric sheet by, for example, gravure printing or screen printing. With such a configuration, a dielectric sheet on which a pattern of the first internal electrode layer and a pattern of the first dummy electrode are formed, and a dielectric sheet on which a pattern of the second internal electrode layer and a pattern of the second dummy electrode are formed are prepared.

It is possible to control the length in the length direction z connecting the first end surface and the second end surface of the first dummy electrode and the second dummy electrode, by changing, for example, the size or arrangement of the pattern of the gravure printing plate used herein. It is also possible to control the length in the length direction z connecting the first end surface and the second end surface between the third extension electrode portion and the second dummy electrode, and the length in the length direction z connecting the first end surface and the second end surface between the fourth extension electrode portion and the second dummy electrode.

Further, for example, in a case where a printing pattern of the internal electrode layer and the dummy electrode is formed by gravure printing, it is possible to respectively form the desired internal electrode layer and dummy electrode by designing the gravure plate used in the gravure printing, based on the graphical pattern of the first internal electrode layer and the first dummy electrode, and by changing the design to a configuration corresponding to the graphical pattern of the second internal electrode layer and the second dummy electrode. In this case, it is possible to change the thickness in the lamination direction by changing the groove of the gravure plate, and it is possible to change the shape of the dummy electrode of this configuration by changing the groove width of the gravure plate.

Furthermore, in a case where a printing pattern of the internal electrode layer and the dummy electrode is formed by screen printing, it is possible to respectively form the desired internal electrode layer and dummy electrode by designing the screen printing mask, based on the graphical pattern of the first internal electrode layer and the first dummy electrode, and by changing the design to a configuration corresponding to the graphical pattern of the second internal electrode layer and the second dummy electrode.

Subsequently, a predetermined number of dielectric sheets for outer layers, on which the patterns of the internal electrode layers and the dummy electrodes are not printed, are laminated to form a portion that becomes the second main surface-side outer layer portion on the second main surface side. Then, dielectric sheets on which the graphical patterns of the first internal electrode layer and the first dummy electrode are printed, and dielectric sheets on which the graphical patterns of the second internal electrode layer and the second dummy electrode are printed, are sequentially laminated on the portion that becomes the second main surface-side outer layer portion, so as to form a portion that becomes the inner layer portion. Thereafter, on the portion that becomes the inner layer portion, a predetermined number of dielectric sheets for outer layers, on which the patterns of the internal electrode layers and the dummy electrodes are not printed, are further laminated to form a portion that becomes the first main surface-side outer layer portion on the first main surface side. Thus, a multilayer sheet is fabricated.

Subsequently, if necessary, the multilayer body sheet is pressure-bonded in the lamination direction by, for example, hydrostatic pressing, and a multilayer block is fabricated.

Thereafter, the multilayer block is cut into a predetermined shape and size to obtain a green multilayer body chip. At this time, for example, barrel polishing or the like may be performed on the green multilayer body chip to round the corners and edges of the multilayer body chip.

Subsequently, the green multilayer body chip is fired, and a multilayer body is produced, in which the first internal electrode layer and the second internal electrode layer are disposed inside the multilayer body, the first internal electrode layer is extended to the first end surface, and the second internal electrode layer is extended to the second end surface. It is preferable that the firing temperature of the green multilayer body chip is, for example, between about 900° C. and about 1300° C. inclusive, although the temperature depends on the materials of the ceramic and the electrically conductive paste for the internal electrode layers.

Subsequently, a third base electrode layer 32c of the third external electrode 30c is formed on the first lateral surface 12c of the multilayer body 12 obtained by firing, and a fourth base electrode layer 32d of the fourth external electrode 30d is formed on the second lateral surface 12d of the multilayer body 12. In a case where a fired layer is formed as the base electrode layer 32, an electrically conductive paste including a glass component and a metal component is applied, and then a baking process is performed, so that a fired layer is formed as the base electrode layer 32. It is preferable that the temperature of the baking process in this case is, for example, between about 700° C. and about 900° C. inclusive.

Next, a first base electrode layer 32a of the first external electrode 30a is formed on the first end surface 12e of the multilayer body 12 obtained by firing, and a second base electrode layer 32b of the second external electrode 30b is formed on the second end surface 12f of the multilayer body 12. Similarly to the formation of the base electrode layers 32 of the third external electrode 30c and the fourth external electrode 30d, in a case where a fired layer is formed as the base electrode layer 32, an electrically conductive paste including a glass component and a metal component is applied, and then a baking process is performed, so that a fired layer is formed as the base electrode layer 32. It is preferable that the temperature of the baking process in this case is, for example, between about 700° C. and about 900° C. inclusive.

In a case where the base electrode layer is formed using an electrically conductive resin layer, the electrically conductive resin layer can be formed by the following method. The electrically conductive resin layer may be formed on the surface of the fired layer, or may be directly formed on the surface of the multilayer body 12 alone without forming the fired layer. As a method of forming the electrically conductive resin layer, for example, an electrically conductive resin paste including a thermosetting resin and a metal component is applied onto the fired layer or the surface of the multilayer body 12, followed by heat treatment at a temperature between about 250° C. and about 550° C. inclusive to thermally cure the resin, thus forming the electrically conductive resin layer. It is preferable that the atmosphere during the heat treatment is, for example, a nitrogen (N₂) atmosphere. In addition, in order to prevent scattering of the resin and oxidation of the various metal components, it is preferable that the oxygen concentration is, for example, about 100 ppm or less.

In a case where the base electrode layer is formed as a thin film layer, it is possible to form the base electrode layer by a thin-film forming method, such as a sputtering method or a vapor deposition method, for example. The base electrode layer formed as a thin film layer is defined as a layer including deposited metal particles with a thickness of, for example, about 1 μm or less.

### Thin Film Layer

In a case where the base electrode layer 32 is formed as a thin film layer, masking or the like may be performed, and the base electrode layer can be formed by, for example, a sputtering method or a vapor deposition method or the like, in a region where the external electrode 30 is to be formed. The base electrode layer formed as a thin film layer is defined as a layer including deposited metal particles with a thickness of, for example, about 1 μm or less.

### Plated Electrodes

Furthermore, it is possible to form the external electrode as a plating electrode solely with a plated layer, without providing a base electrode layer 32. In such a case, it is possible to form the external electrode by the following method, for example.

Any one or more of the first to fourth external electrodes 30a to 30d may be directly formed of a plated layer on the surface of the multilayer body 12, without providing the base electrode layer 32. That is, the multilayer ceramic capacitor 10 may be configured to include a plated layer that is electrically connected directly to the first internal electrode layer 16a and the second internal electrode layer 16b. Either electrolytic plating or electroless plating may be used for the plating process. However, electroless plating requires pretreatment using a catalyst or the like to increase the plating deposition rate, which leads to a drawback of increased step complexity. Accordingly, it is preferable to use electrolytic plating in general. As the plating method, it is preferable to use barrel plating, for example. In addition, if necessary, an upper plated electrode may also be formed on the surface of the lower plated electrode in the same manner.

Subsequently, if necessary, a plated layer is formed on the surface of the base electrode layer 32, the surface of the electrically conductive resin layer or the surface of the lower plated electrode, and the surface of the upper plated electrode. More specifically, in the present example embodiment, the plated layer is formed on the base electrode layer 32, which is a fired layer. The Ni plated layer and the Sn plated layer are sequentially formed, for example, by a barrel plating method. In performing the plating process, either electrolytic plating or electroless plating may be used. However, electroless plating requires pretreatment using a catalyst or the like in order to increase the plating deposition rate, which leads to a drawback of increased step complexity. Accordingly, it is preferable to use electrolytic plating in general.

In this manner, the multilayer ceramic capacitor 10 as shown in FIG. 1 is manufactured.

### 3. EXPERIMENTAL EXAMPLES

Next, experiments were conducted to confirm the advantageous effects of multilayer ceramic capacitors according to example embodiments of the present invention described above.

### A. Experimental Example 1

In Experimental Example 1, samples of multilayer bodies with different dimensions were produced, and the length in the width direction y of the first and second dummy electrodes was varied to conduct a delamination confirmation test. The specifications of each sample used in the Experimental Examples are described below.

### A-1. First Dummy Electrode

### (1) Sample Specifications in Experimental Example 1-1 and Experimental Example 1-2

In Experimental Example 1-1 and Experimental Example 1-2, multilayer bodies with different dimensions were produced according to the method of manufacturing the multilayer ceramic capacitor described above, and samples were prepared in which the length in the width direction y of the first dummy electrode was varied. The length of the first dummy electrode in the length direction z was set to about 50% of the dimension of the multilayer body in the length direction z.

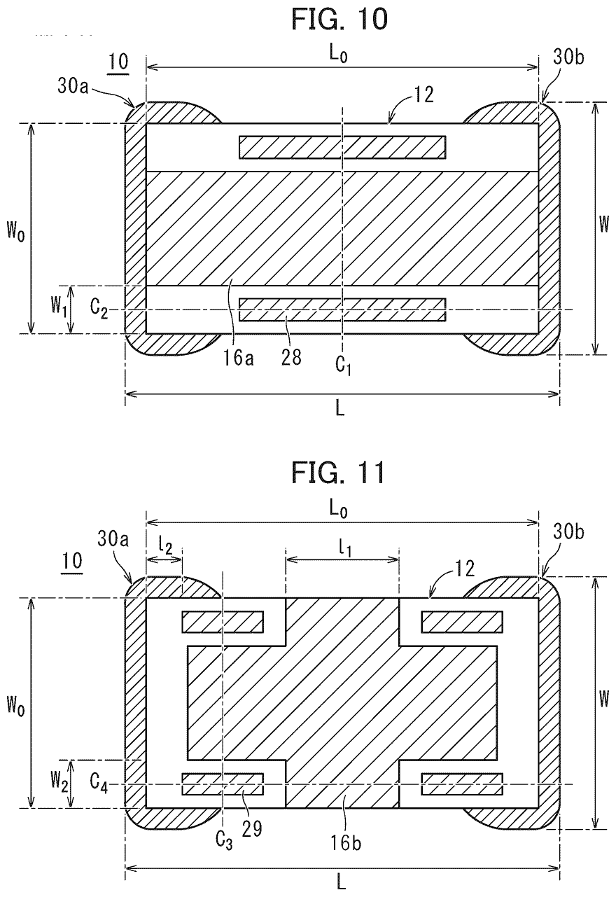

As shown in FIG. 10, the first dummy electrodes were provided between the first internal electrode layer and the first lateral surface, and between the first internal electrode layer and the second lateral surface (i.e., in regions corresponding to the lateral portions of the multilayer body).

More specifically, as shown in FIG. 10, the first dummy electrode provided between the first internal electrode layer and the first lateral surface is arranged such that the center in the length direction z of the first dummy electrode coincides with a center line c1 indicating about ½ L of the multilayer body. In addition, this first dummy electrode is arranged such that the center in the width direction y of the first dummy electrode coincides with a center line c2 in the width direction y of the distance w1 between the first internal electrode layer and the first lateral surface. Furthermore, the first dummy electrode provided between the first internal electrode layer and the second lateral surface is similarly arranged. In addition, the second dummy electrodes are not provided in the multilayer body used in Experimental Example 1-1 and Experimental Example 1-2.

### Experimental Example 1-1

Configuration of multilayer ceramic capacitor: Three-terminal
Dimension L0 of multilayer body in length direction z: about 1.10 mm±0.05 mm
Dimension W0 of multilayer body in width direction y: about 0.80 mm±0.05 mm
Dimension T0 of multilayer body in lamination direction: about 0.50 mm±0.05 mm
Main component of dielectric layer in inner layer portion: BaTiO₃
Main component of dielectric layer in outer layer portion: BaTiO₃
Main component of first internal electrode layer: Ni
Thickness of first internal electrode layer: about 0.50 μm±0.10 μm Main component of first dummy electrode: Ni
Thickness of first dummy electrode: about 0.50 μm±0.10 μm
Length of first dummy electrode in width direction y: See Table 1
Main component of second internal electrode layer: Ni
Thickness of second internal electrode layer: about 0.50 μm±0.10 μm
Length of extension electrode portion of second internal electrode layer in width direction y: about 220 μm
Distance from first internal electrode layer to lateral surface: about 52 μm
Distance from counter electrode portion of second internal electrode layer to lateral surface: about 52 μm
Distance from counter electrode portion of second internal electrode layer to end surface: about 52 μm
Total number of first internal electrode layers and second internal electrode layers: 478

### Experimental Example 1-2

Configuration of multilayer ceramic capacitor: Three-terminal
Dimension L0 of multilayer body in length direction z: about 1.10 mm±0.05 mm
Dimension W0 of multilayer body in width direction y: about 0.60 mm±0.05 mm
Dimension T0 of multilayer body in lamination direction: about 0.40 mm±0.05 mm
Main component of dielectric layer of inner layer portion: BaTiO₃
Main component of dielectric layer of outer layer portion: BaTiO₃
Main component of first internal electrode layer: Ni
Thickness of first internal electrode layer: about 0.50 μm±0.10 μm
Main component of first dummy electrode: Ni
Thickness of first dummy electrode: about 0.50 μm±0.10 μm
Length of first dummy electrode in width direction y: See Table 2
Main component of second internal electrode layer: Ni
Thickness of second internal electrode layer: about 0.50 μm±0.10 μm
Length of extension electrode portion of second internal electrode layer in width direction y: about 130 μm
Distance from first internal electrode layer to lateral surface: about 82 μm
Distance from counter electrode portion of second internal electrode layer to lateral surface: about 82 μm
Distance from counter electrode portion of second internal electrode layer to end surface: about 62 μm
Total number of first internal electrode layers and second internal electrode layers: 260

### (2) Method of Calculating Ratio of First Dummy Electrode in Width Direction

First, the multilayer body described above was fixed with resin. Next, the multilayer body was polished up to about ½ of the dimension in the length direction such that the first dummy electrode was exposed on the surface in the width direction x lamination direction (WT surface). On the surface in the width direction x lamination direction (WT surface) obtained by polishing, the region between the first internal electrode layer and the lateral surface was observed using a digital microscope (VHX-8000 manufactured by Keyence, magnification: about 1000×).

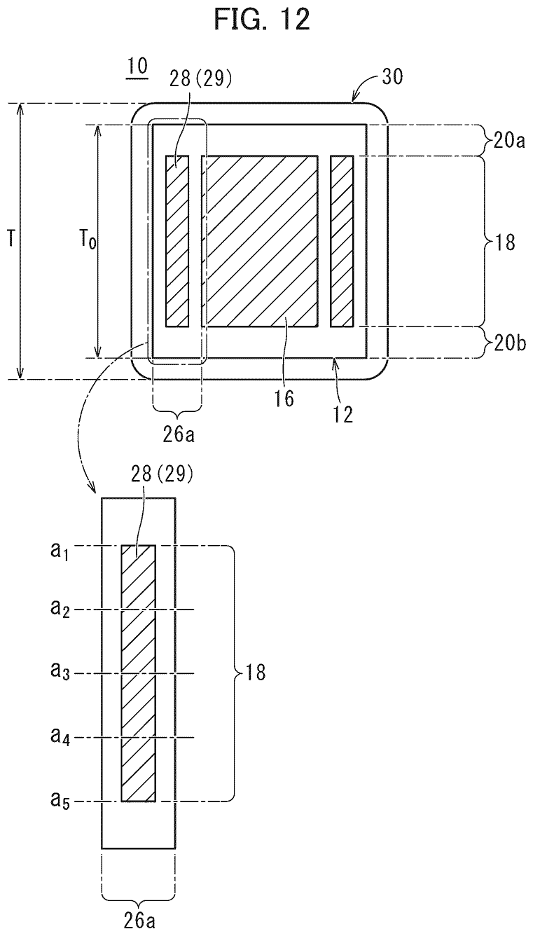

In the surface in the width direction x lamination direction (WT surface) obtained by polishing, as shown in an enlarged view of the W-gap portion in FIG. 12, when the dimension of the inner layer portion in the lamination direction is equally or substantially equally divided into four, the ratio of the length in the width direction y of the first dummy electrode to the distance in the width direction y from the lateral surface closest to the first dummy electrode to the first internal electrode layer (w1) was measured in a total of five regions (a1 to a5), in which the first dummy electrodes are present and which are defined between the extension lines of the boundaries and the extension lines of the boundaries between the inner layer portion and each outer layer portion. Based on the method described above, the average value of the ratio of the length of the first dummy electrode in the width direction y to the distance w1 in the width direction y from the lateral surface closest to the first dummy electrode to the first internal electrode layer was defined as the first dummy electrode ratio, measured using 1,000 multilayer bodies.

### (3) Method of Confirming Delamination

The surface in the length direction x lamination direction (LT cross section) of the multilayer body as a sample was exposed, and the samples in which delamination was observed were counted. In each experimental example, 1,000 multilayer bodies were prepared.

The evaluation results are shown in Tables 1 and 2.

TABLE 1

| | FIRST DUMMY | DELAMINATION |
|---|---|---|
| | ELECTRODE | OCCURRENCE |
| SAMPLE NO. | RATIO (%) | RATE (%) |
| 1 | NO FIRST DUMMY | 68.3 |
| | ELECTRODE | |
| 2 | 10 | 23.4 |
| 3 | 20 | 14.2 |
| 4 | 40 | 6.5 |
| 5 | 66 | 0.8 |
| 6 | 68 | 0.3 |
| 7 | 70 | 0.0 |
| 8 | 72 | 0.0 |
| 9 | 64 | 0.0 |
| 10 | 80 | 0.0 |
| 11 | 90 | 0.0 |
| 12 | 95 | 0.0 |

TABLE 2

| | FIRST DUMMY | DELAMINATION |
|---|---|---|
| | ELECTRODE | OCCURRENCE |
| SAMPLE NO. | RATIO (%) | RATE (%) |
| 13 | NO FIRST DUMMY | 62.3 |
| | ELECTRODE | |
| 14 | 10 | 28.1 |
| 15 | 20 | 18.0 |
| 16 | 40 | 11.8 |
| 17 | 66 | 3.2 |
| 18 | 68 | 0.7 |
| 19 | 70 | 0.2 |
| 20 | 72 | 0.0 |
| 21 | 64 | 0.0 |
| 22 | 80 | 0.0 |
| 23 | 90 | 0.0 |
| 24 | 95 | 0.0 |

### (4) Summary

According to Experimental Example 1-1, as shown in Sample Nos. 5 through 12, when the first dummy electrode ratio was set to about 66% or more, a favorable result was obtained, with a delamination occurrence rate of about 1% or less. Similarly, according to Experimental Example 1-2, as shown in Sample Nos. 18 through 24, when the first dummy electrode ratio was set to about 68% or more, a favorable result was also obtained, with a delamination occurrence rate of about 1% or less.

On the other hand, according to Experimental Example 1-1, as shown in Sample Nos. 1 through 4, when the first dummy electrode ratio was set to about 40% or less, the delamination occurrence rate exceeded about 1%. In particular, Sample No. 1, which had no first dummy electrode, exhibited a relatively high delamination occurrence rate of about 68.3% compared with other samples including the first dummy electrodes. According to Experimental Example 1-2, as shown in Sample Nos. 13 through 17, when the first dummy electrode ratio was set to about 66% or less, the delamination occurrence rate exceeded about 1%. In particular, Sample No. 13, which included no first dummy electrode, exhibited a relatively high delamination occurrence rate of about 62.3% compared with other samples including the second dummy electrodes.

From the above results, it was determined that setting the first dummy electrode ratio to at least about 68% or more can reduce or prevent the occurrence of delamination.

### A-2. Second Dummy Electrode

### (1) Sample Specifications in Experimental Example 1-3 and Experimental Example 1-4

In Experimental Examples 1-3 and 1-4, multilayer bodies with different dimensions were produced according to the method of manufacturing the multilayer ceramic capacitor described above, and samples were prepared in which the length of the second dummy electrode in the width direction y was varied. The length of the second dummy electrodes in the length direction z was set to about 50% of the distance from the third extension electrode portion of the second internal electrode layer to each of the end surfaces, or about 50% of the distance from the fourth extension electrode portion of the second internal electrode layer to each of the end surfaces.

As shown in FIG. 11, the second dummy electrode is provided in a region between the second counter electrode portion of the second internal electrode layer and the first lateral surface and the second lateral surface (i.e., in a region corresponding to the lateral portion of the multilayer body), toward the first end surface side. The second dummy electrode is also provided in a region between the second counter electrode portion of the second internal electrode layer and the first lateral surface and the second lateral surface (i.e., in a region corresponding to the lateral portion of the multilayer body), toward the second end surface side.

More specifically, as shown in FIG. 11, in a region between the second counter electrode portion of the second internal electrode layer and the first lateral surface, the second dummy electrode provided toward the first end surface side is arranged such that the center line c3 representing the distance from the third extension electrode portion of the second internal electrode layer to the first end surface coincides with the center of the second dummy electrode in the length direction z. This second dummy electrode is also arranged such that the center line c4 in the width direction y of the distance w2 between the second counter electrode portion of the second internal electrode layer and the first lateral surface coincides with the center of the second dummy electrode in the width direction y. The other second dummy electrodes are similarly arranged. In addition, the multilayer bodies used in Experimental Examples 1-3 and 1-4 did not include first dummy electrodes.

### Experimental Example 1-3

Configuration of multilayer ceramic capacitor: Three-terminal
Dimension L0 of multilayer body in length direction z: about 1.10 mm±0.05 mm
Dimension W0 of multilayer body in width direction y: about 0.80 mm±0.05 mm
Dimension T0 of multilayer body in lamination direction: about 0.50 mm±0.05 mm
Main component of dielectric layers of inner layer portion: BaTiO₃
Main component of dielectric layers of outer layer portion: BaTiO₃
Main component of first internal electrode layer: Ni
Thickness of first internal electrode layer: about 0.50 μm±0.10 μm
Main component of second internal electrode layer: Ni
Thickness of second internal electrode layer: about 0.50 μm±0.10 μm
Length of extension electrode portion of second internal electrode layer in width direction y: about 220 μm
Main component of second dummy electrode: Ni
Thickness of second dummy electrode: about 0.50 μm±0.10 μm
Length of second dummy electrode in width direction y: See Table 3
Distance from first internal electrode layer to lateral surface: about 52 μm
Distance from counter electrode portion of second internal electrode layer to lateral surface: about 52 μm
Distance from counter electrode portion of second internal electrode layer to end surface: about 52 μm
Total number of first internal electrode layers and second internal electrode layers: 478

### Experimental Example 1-4

Configuration of multilayer ceramic capacitor: Three-terminal (see FIG. 1)
Dimension L0 of multilayer body in length direction z: about 1.10 mm±0.05 mm
Dimension W0 of multilayer body in width direction y: about 0.60 mm±0.05 mm
Dimension T0 of multilayer body in lamination direction: about 0.40 mm±0.05 mm
Main component of dielectric layers of inner layer portion: BaTiO₃
Main component of dielectric layers of outer layer portion: BaTiO₃
Main component of first internal electrode layer: Ni
Thickness of first internal electrode layer: about 0.50 μm±0.10 μm
Main component of second internal electrode layer: Ni
Thickness of second internal electrode layer: about 0.50 μm±0.10 μm
Length of extension electrode portion of second internal electrode layer in width direction y: about 130 μm
Main component of second dummy electrode: Ni
Thickness of second dummy electrode: about 0.50 μm±0.10 μm
Length of second dummy electrode in width direction y: See Table 4
Distance from first internal electrode layer to lateral surface: about 82 μm
Distance from counter electrode portion of second internal electrode layer to lateral surface: about 82 μm
Distance from counter electrode portion of second internal electrode layer to end surface: about 62 μm
Total number of first internal electrode layers and second internal electrode layers: 260

### (2) Method of Calculating Ratio of Second Dummy Electrode in Width Direction

The multilayer body described above was fixed with resin. Next, the multilayer body was polished up to about ¼ of the dimension in the length direction such that the second dummy electrode was exposed on the surface in the width direction x lamination direction (WT surface). That is, the polishing was performed for the dimension in the length direction z where the extension electrode portion of the second internal electrode layer does not exist. On the surface in the width direction x lamination direction (WT surface) obtained by polishing, the region between the second internal electrode layer (internal electrode layer for GND) and the lateral surface was observed using a digital microscope (VHX-8000 manufactured by Keyence, magnification: about 1000×).

In the surface in the width direction x lamination direction (WT surface) obtained by polishing, as shown in an enlarged view of the W-gap portion in FIG. 12, when the dimension of the inner layer portion in the lamination direction is equally or substantially equally divided into four, in a total of five regions (a1 to a5) in which the second dummy electrodes are present and which are defined between the extension lines of the boundaries and the extension lines of the boundaries between the inner layer portion and each outer layer portion, the ratio of the length in the width direction y of the second dummy electrode to the distance in the width direction y from the lateral surface closest to the second dummy electrode to the second internal electrode layer (w2) was measured. Based on the above method, the average value of the ratio of the length of the second dummy electrode in the width direction y to the distance w2 in the width direction y from the lateral surface closest to the second dummy electrode to the second internal electrode layer was defined as the second dummy electrode ratio, measured using 1,000 multilayer bodies.

### (3) Method of Confirming Delamination

The confirmation was performed using the same method as that used in Experimental Examples 1-1 and 1-2.

The evaluation results are shown in Tables 3 and 4.

TABLE 3

| | SECOND DUMMY | DELAMINATION |
|---|---|---|
| | ELECTRODE | OCCURRENCE |
| SAMPLE NO. | RATIO (%) | RATE (%) |
| 25 | NO SECOND DUMMY | 72.2 |
| | ELECTRODE | |
| 26 | 10 | 25.6 |
| 27 | 20 | 10.3 |
| 28 | 40 | 4.2 |
| 29 | 66 | 1.2 |
| 30 | 68 | 0.0 |
| 31 | 70 | 0.0 |
| 32 | 72 | 0.0 |
| 33 | 74 | 0.0 |
| 34 | 80 | 0.0 |
| 35 | 90 | 0.0 |
| 36 | 95 | 0.0 |

TABLE 4

| | SECOND DUMMY | DELAMINATION |
|---|---|---|
| | ELECTRODE | OCCURRENCE |
| SAMPLE NO. | RATIO (%) | RATE (%) |
| 37 | NO SECOND DUMMY | 60.1 |
| | ELECTRODE | |
| 38 | 10 | 30.1 |
| 39 | 20 | 25.1 |
| 40 | 40 | 13.2 |
| 41 | 66 | 8.2 |
| 42 | 68 | 3.1 |
| 43 | 70 | 0.7 |
| 44 | 72 | 0.0 |
| 45 | 74 | 0.0 |
| 46 | 80 | 0.0 |
| 47 | 90 | 0.0 |
| 48 | 95 | 0.0 |

### (4) Summary

According to Experimental Example 1-3, as shown in Sample Nos. 30 through 36, when the second dummy electrode ratio was set to about 68% or more, a favorable result was obtained in which the delamination occurrence rate was about 1% or less. According to Experimental Example 1-4, as shown in Sample Nos. 43 through 48, when the first dummy electrode ratio was set to about 70% or more, a favorable result was obtained in which the delamination occurrence rate was about 1% or less.

On the other hand, according to Experimental Example 1-3, as shown in Sample Nos. 25 through 29, when the second dummy electrode ratio was set to about 66% or less, a result was obtained in which the delamination occurrence rate exceeded about 1%. In particular, Sample No. 25 was a sample in which the second dummy electrode was not provided, and thus the delamination occurrence rate was relatively high, about 72.2%, as compared to the other samples in which the first dummy electrode was provided. Further, according to Experimental Example 1-4, as shown in Sample Nos. 37 through 42, when the second dummy electrode ratio was set to about 68% or less, a result was obtained in which the delamination occurrence rate exceeded about 1%. In particular, Sample No. 37 was a sample in which the second dummy electrode was not provided, and thus the delamination occurrence rate was relatively high, about 60.1%, as compared to the other samples in which the second dummy electrode was provided.

From the above results, it was determined that the delamination occurrence can be reduced or prevented by setting the second dummy electrode ratio to at least about 70% or more.

### B. Experimental Example 2

In Experimental Example 2, multilayer ceramic capacitor samples with different dimensions were produced, and the length in the width direction y of the first and second dummy electrodes was varied to conduct an experiment evaluating moisture resistance reliability. The specifications of the samples used in each Experimental Example are described below.

### B-1. First Dummy Electrode

### (1) Sample Specifications in Experimental Examples 2-1 and 2-2

In Experimental Examples 2-1 and 2-2, multilayer ceramic capacitors with different dimensions were produced according to the above-described method of manufacturing a multilayer ceramic capacitor, and samples were prepared in which the width y of the first dummy electrode was varied. The length in the z direction of the first dummy electrode was set to about 50% of the length of the multilayer body in the z direction. The arrangement of the first dummy electrode was the same as that shown in FIG. 10 and as used in Experimental Examples 1-1 and 1-2. In addition, the multilayer bodies used in Experimental Examples 2-1 and 2-2 did not include any second dummy electrodes.

### Experimental Example 2-1

Configuration of multilayer ceramic capacitor: Three-terminal
Dimension L of multilayer ceramic capacitor in length direction z: about 1.20 mm±0.05 mm
Dimension W of multilayer ceramic capacitor in width direction y: about 0.90 mm±0.05 mm
Dimension T of multilayer ceramic capacitor in lamination direction: about 0.60 mm±0.05 mm
Main component of dielectric layers of inner layer portion: BaTiO₃
Main component of dielectric layers of outer layer portion: BaTiO₃
Main component of first internal electrode layer: Ni
Thickness of first internal electrode layer: about 0.50 μm±0.10 μm
Main component of first dummy electrode: Ni
Thickness of first dummy electrode: about 0.50 μm±0.10 μm
Length of first dummy electrode in width direction y: See Table 5
Main component of second internal electrode layer: Ni
Thickness of second internal electrode layer: about 0.50 μm±0.10 μm
Length of extension electrode portion of second internal electrode layer in width direction y: about 220 μm
Distance from first internal electrode layer to lateral surface: about 52 μm
Distance from counter electrode portion of second internal electrode layer to lateral surface: about 52 μm
Distance from counter electrode portion of second internal electrode layer to end surface: about 52 μm
Configuration of first external electrodes and second external electrodes: Base electrode layer (Cu), plated layer (two-layer structure: Ni/Sn plating)
Configuration of third external electrodes and fourth external electrodes: Base electrode layer (Cu), plated layer (two-layer structure: Ni/Sn plating)
Total number of first internal electrode layers and second internal electrode layers: 478

### Experimental Example 2-2

Configuration of multilayer ceramic capacitor: Three-terminal
Dimension L of multilayer ceramic capacitor in length direction z: about 1.15 mm±0.05 mm
Dimension W of multilayer ceramic capacitor in width direction y: about 0.65 mm±0.05 mm
Dimension T of multilayer ceramic capacitor in lamination direction: about 0.45 mm±0.05 mm
Main component of dielectric layers of inner layer portion: BaTiO₃
Main component of dielectric layers of outer layer portion: BaTiO₃
Main component of first internal electrode layer: Ni
Thickness of first internal electrode layer: about 0.50 μm±0.10 μm
Main component of first dummy electrode: Ni
Thickness of first dummy electrode: about 0.50 μm±0.10 μm
Length of first dummy electrode in width direction y: See Table 6
Main component of second internal electrode layer: Ni
Thickness of second internal electrode layer: about 0.50 μm±0.10 μm
Length of extension electrode portion of second internal electrode layer in width direction y: about 130 μm
Distance from first internal electrode layer to lateral surface: about 82 μm
Distance from counter electrode portion of second internal electrode layer to lateral surface: about 82 μm
Distance from counter electrode portion of second internal electrode layer to end surface: about 62 μm
Configuration of first external electrodes and second external electrodes: Base electrode layer (Cu), plated layer (two-layer structure: Ni/Sn plating)
Configuration of third external electrodes and fourth external electrodes: Base electrode layer (Cu), plated layer (two-layer structure: Ni/Sn plating)
Total number of first internal electrode layers and second internal electrode layers: 260

### (2) Method of Calculating Ratio of First Dummy Electrode in Width Direction

The calculation was performed by the same method as in Experimental Examples 1-1 and 1-2.

### (3) Moisture Resistance Reliability Test Method

In each multilayer ceramic capacitor with no delamination, soldering was performed to mount the capacitor on a wiring board, and the insulation resistance value was measured. Each sample of the multilayer ceramic capacitors mounted on the wiring board was placed in a high-temperature, high-humidity chamber, and under an environment of about 125° C. and a relative humidity of about 95% RH, a DC voltage of about 4 V was applied between the first external electrode and the second external electrode of each multilayer ceramic capacitor and maintained for about 144 hours. After the moisture resistance test, the insulation resistance of each sample of the multilayer ceramic capacitor was measured, and if the insulation resistance value after the moisture resistance test was decreased by more than one order of magnitude compared to that before the moisture resistance test, it was determined as NG. Then, (number of NGs/70)×100 was calculated, and this value was defined as the NG rate.

The evaluation results are shown in Tables 5 and 6.

TABLE 5

| | FIRST DUMMY | |
|---|---|---|
| | ELECTRODE | NG |
| SAMPLE NO. | RATIO (%) | RATIO (%) |
| 49 | NO FIRST DUMMY | 0.0 |
| | ELECTRODE | |
| 50 | 10 | 0.0 |
| 51 | 20 | 0.0 |
| 52 | 40 | 0.0 |
| 53 | 66 | 0.0 |
| 54 | 68 | 0.0 |
| 55 | 70 | 0.0 |
| 56 | 72 | 0.0 |
| 57 | 74 | 0.0 |
| 58 | 80 | 0.0 |
| 59 | 90 | 0.0 |
| 60 | 93 | 0.0 |
| 61 | 95 | 0.0 |
| 62 | 96 | 0.0 |
| 63 | 96.5 | 1.4 |
| 64 | 97 | 7.1 |
| 65 | 98 | 12.9 |
| 66 | 99 | 28.6 |

TABLE 6

| | FIRST DUMMY | |
|---|---|---|
| | ELECTRODE | NG |
| SAMPLE NO. | RATIO (%) | RATIO (%) |
| 67 | NO FIRST DUMMY | 0.0 |
| | ELECTRODE | |
| 68 | 10 | 0.0 |
| 69 | 20 | 0.0 |
| 70 | 40 | 0.0 |
| 71 | 66 | 0.0 |
| 72 | 68 | 0.0 |
| 73 | 70 | 0.0 |
| 74 | 72 | 0.0 |
| 75 | 74 | 0.0 |
| 76 | 80 | 0.0 |
| 77 | 90 | 0.0 |
| 78 | 93 | 0.0 |
| 79 | 97 | 0.0 |
| 80 | 97.5 | 1.4 |
| 81 | 98 | 1.4 |
| 82 | 98.5 | 10.0 |
| 83 | 99 | 22.9 |

### (4) Summary

According to Experimental Example 2-1, as shown in Sample Nos. 50 through 62, when the first dummy electrode ratio was about 96% or less, a favorable result was obtained with an NG rate of about 1% or less in the moisture resistance reliability test. Similarly, in Experimental Example 2-2, as shown in Sample Nos. 67 through 79, when the first dummy electrode ratio was about 97% or less, the NG rate was also about 1% or less, indicating good reliability.

On the other hand, according to Experimental Example 2-1, as shown in Sample Nos. 63 through 66, when the first dummy electrode ratio was about 96.5% or more, the NG rate exceeded about 1% in the moisture resistance reliability test. Similarly, in Experimental Example 2-2, as shown in Sample Nos. 80 through 83, when the first dummy electrode ratio was about 97.5% or more, the NG rate exceeded about 1%.

From these results, it was determined that setting the first dummy electrode ratio to about 96% or less makes it possible to obtain a multilayer ceramic capacitor with improved moisture resistance reliability.

### B-2. Second Dummy Electrode

### (1) Sample Specifications in Experimental Examples 2-3 and 2-4

In Experimental Examples 2-3 and 2-4, multilayer bodies with different dimensions were produced according to the above-described method of manufacturing a multilayer ceramic capacitor, and samples were prepared in which the width y of the second dummy electrode was varied. The length of the second dummy electrode in the z direction was set to about 50% of the distance from the extension electrode portion of the second internal electrode layer to the first end surface, or from the extension electrode portion of the second internal electrode layer to the second end surface. The arrangement of the second dummy electrodes was the same or substantially the same as shown in FIG. 11 and as used in Experimental Examples 1-3 and 1-4. In addition, the multilayer bodies used in Experimental Examples 2-3 and 2-4 did not include any first dummy electrodes.

### Experimental Example 2-3

Configuration of multilayer ceramic capacitor: Three-terminal
Dimension L of multilayer ceramic capacitor in length direction z: about 1.20 mm±0.05 mm
Dimension W of multilayer ceramic capacitor in width direction y: about 0.90 mm±0.05 mm
Dimension T of multilayer ceramic capacitor in lamination direction: about 0.60 mm±0.05 mm
Main component of dielectric layers of inner layer portion: BaTiO₃
Main component of dielectric layers of outer layer portion: BaTiO₃
Main component of first internal electrode layer: Ni
Thickness of first internal electrode layer: about 0.50 μm±0.10 μm
Main component of second internal electrode layer: Ni
Thickness of second internal electrode layer: about 0.50 μm±0.10 μm
Length of extension electrode portion of second internal electrode layer in width direction y: about 220 μm
Main component of second dummy electrode: Ni
Thickness of second dummy electrode: about 0.50 μm±0.10 μm
Width y of second dummy electrode: See Table 7
Distance from first internal electrode layer to lateral surface: about 52 μm
Distance from counter electrode portion of second internal electrode layer to lateral surface: about 52 μm
Distance from counter electrode portion of second internal electrode layer to end surface: about 52 μm
Configuration of first external electrodes and second external electrodes: Base electrode layer (Cu), plated layer (two-layer structure: Ni/Sn plating)
Configuration of third external electrodes and fourth external electrodes: Base electrode layer (Cu), plated layer (two-layer structure: Ni/Sn plating)
Total number of first internal electrode layers and second internal electrode layers: 478

### Experimental Example 2-4

Configuration of multilayer ceramic capacitor: Three-terminal
Dimension L of multilayer ceramic capacitor in length direction z: about 1.15 mm±0.05 mm
Dimension W of multilayer ceramic capacitor in width direction y: about 0.65 mm±0.05 mm
Dimension T of multilayer ceramic capacitor in lamination direction: about 0.45 mm±0.05 mm
Main component of dielectric layers of inner layer portion: BaTiO₃
Main component of dielectric layers of outer layer portion: BaTiO₃
Main component of first internal electrode layer: Ni
Thickness of first internal electrode layer: about 0.50 μm±0.10 μm
Main component of second internal electrode layer: Ni
Thickness of second internal electrode layer: about 0.50 μm±0.10 μm
Length of extension electrode portion of second internal electrode layer in width direction y: about 130 μm
Main component of second dummy electrode: Ni
Thickness of second dummy electrode: about 0.50 μm±0.10 μm
Width y of second dummy electrode: See Table 8
Distance from first internal electrode layer to lateral surface: about 82 μm
Distance from counter electrode portion of second internal electrode layer to lateral surface: about 82 μm
Distance from counter electrode portion of second internal electrode layer to end surface: about 62 μm
Configuration of first external electrodes and second external electrodes: Base electrode layer (Cu), plated layer (two-layer structure: Ni/Sn plating)
Configuration of third external electrodes and fourth external electrodes: Base electrode layer (Cu), plated layer (two-layer structure: Ni/Sn plating)
Total number of first internal electrode layers and second internal electrode layers: 260

### (2) Method of Calculating Ratio of Second Dummy Electrode in Width Direction

The calculation was performed by the same method as in Experimental Examples 1-3 and 1-4.

### (3) Moisture Resistance Reliability Test Method

The test was performed using the same method as that used in Experimental Examples 2-3 and 2-4.

The evaluation results are shown in Tables 7 and 8.

TABLE 7

| | SECOND DUMMY | |
|---|---|---|
| | ELECTRODE | NG |
| SAMPLE NO. | RATIO (%) | RATIO (%) |
| 84 | NO SECOND | 0.0 |
| | DUMMY | |
| | ELECTRODE | |
| 85 | 10 | 0.0 |
| 86 | 20 | 0.0 |
| 87 | 40 | 0.0 |
| 88 | 66 | 0.0 |
| 89 | 68 | 0.0 |
| 90 | 70 | 0.0 |
| 91 | 72 | 0.0 |
| 92 | 74 | 0.0 |
| 93 | 80 | 0.0 |
| 94 | 90 | 0.0 |
| 95 | 93 | 0.0 |
| 96 | 95 | 0.0 |
| 97 | 96 | 0.0 |
| 98 | 96.5 | 2.9 |
| 99 | 97 | 5.7 |
| 100 | 98 | 14.3 |
| 101 | 99 | 25.7 |

TABLE 8

| | SECOND DUMMY | |
|---|---|---|
| | ELECTRODE | NG |
| SAMPLE NO. | RATIO (%) | RATIO (%) |
| 102 | NO SECOND | 0.0 |
| | DUMMY | |
| | ELECTRODE | |
| 103 | 10 | 0.0 |
| 104 | 20 | 0.0 |
| 105 | 40 | 0.0 |
| 106 | 66 | 0.0 |
| 107 | 68 | 0.0 |
| 108 | 70 | 0.0 |
| 109 | 72 | 0.0 |
| 110 | 74 | 0.0 |
| 111 | 80 | 0.0 |
| 112 | 90 | 0.0 |
| 113 | 93 | 0.0 |
| 114 | 97 | 0.0 |
| 115 | 97.5 | 1.4 |
| 116 | 98 | 4.3 |
| 117 | 98.5 | 7.1 |
| 118 | 99 | 22.9 |

### (4) Summary

According to Experimental Example 2-3, as shown in Sample Nos. 84 through 97, when the second dummy electrode ratio was about 96% or less, a favorable result was obtained with an NG rate of about 1% or less in the moisture resistance reliability test. Similarly, in Experimental Example 2-4, as shown in Sample Nos. 102 through 114, when the second dummy electrode ratio was about 97% or less, the NG rate was also about 1% or less, indicating good reliability.

On the other hand, according to Experimental Example 2-3, as shown in Sample Nos. 98 through 101, when the second dummy electrode ratio was about 96.5% or more, the NG rate exceeded about 1%. Also, in Experimental Example 2-4, as shown in Sample Nos. 115 through 118, when the second dummy electrode ratio was about 97.5% or more, the NG rate exceeded about 1%.

From these results, it was determined that setting the second dummy electrode ratio to about 96% or less makes it possible to obtain a multilayer ceramic capacitor with improved moisture resistance reliability.

### C. Experimental Results

From the above results, it was determined that in Experimental Examples 1-1 to 1-4, the presence of either the first or second dummy electrode enabled the delamination occurrence rate to be reduced to about 30%. Further, according to Experimental Examples 1-1 and 1-2, when the first dummy electrode ratio was about 68% or more, the delamination occurrence rate was sufficiently reduced or prevented. Moreover, according to Experimental Examples 1-3 and 1-4, when the second dummy electrode ratio was about 70% or more, the delamination occurrence rate was also sufficiently reduced or prevented.

According to Experimental Examples 2-1 and 2-3, when the first dummy electrode ratio was about 96% or less, the NG rate in the moisture resistance reliability test was 0%, indicating that there was no issue with moisture resistance. In addition, according to Experimental Examples 2-3 and 2-4, when the second dummy electrode ratio was about 96% or less, the NG rate in the moisture resistance reliability test was also 0%, confirming satisfactory moisture resistance.

In the above-described Experimental Examples, the second dummy electrode is not provided when the first dummy electrode is provided, while the first dummy electrode is not provided when the second dummy electrode is provided. However, even in a case where both the first dummy electrode and the second dummy electrode are provided, it is possible to achieve the advantageous effects of the present invention.

Further, even in cases beyond the scope of the present experiment, where the length of the first dummy electrode in the length direction of the multilayer body is increased, the increase in the proportion of the electrically conductive component can reduce or prevent delamination occurrence.

As described above, example embodiments of the present invention have been disclosed. However, the present invention is not limited to the example embodiments described herein. That is, various modifications may be made to the above-described example embodiments with respect to mechanism, shape, material, quantity, position, or arrangement, without departing from the technical idea and scope of the present invention. Such modifications are also included in the scope of the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor, comprising:
a multilayer body including:
a plurality of dielectric layers that are laminated;
a plurality of internal electrode layers laminated on the dielectric layers;
a first main surface and a second main surface opposed to each other in a lamination direction;
a first lateral surface and a second lateral surface opposed to each other in a width direction orthogonal or substantially orthogonal to the lamination direction; and
a first end surface and a second end surface opposed to each other in a length direction orthogonal or substantially orthogonal to both the lamination direction and the width direction;
a first external electrode on the first end surface;
a second external electrode on the second end surface;
a third external electrode on the first lateral surface; and
a fourth external electrode on the second lateral surface; wherein
the plurality of internal electrode layers include:
a first internal electrode layer in the plurality of dielectric layers and connected to the first external electrode and the second external electrode;
a second internal electrode layer in one or more of the plurality of dielectric layers different from the first internal electrode layer and connected to the third external electrode and the fourth external electrode; and
a first dummy electrode spaced apart from the first internal electrode layer and provided on a same layer surface as the first internal electrode layer; and
the first dummy electrode is not exposed from the first lateral surface, the second lateral surface, the first end surface, or the second end surface.

2. The multilayer ceramic capacitor according to claim 1, further comprising:
a second dummy electrode spaced apart from the second internal electrode layer and provided on a same layer surface as the second internal electrode layer; wherein
the second dummy electrode is not exposed from the first end surface, the second end surface, the first lateral surface, or the second lateral surface.

3. The multilayer ceramic capacitor according to claim 1, wherein a main component of the first dummy electrode is the same as a main component of the first internal electrode layer.

4. The multilayer ceramic capacitor according to claim 1, wherein
a distance between the first dummy electrode and a closer one of the first lateral surface and the second lateral surface is about 1 μm or more; and
a shortest distance between the first dummy electrode and the first internal electrode layer is about 1 μm or more.

5. The multilayer ceramic capacitor according to claim 1, wherein a thickness of the first dummy electrode in the lamination direction is between about 83% and about 120% inclusive of a thickness of the first internal electrode layer in the lamination direction.

6. The multilayer ceramic capacitor according to claim 1, wherein a ratio of the first dummy electrode is between about 68% and about 96% inclusive of a shortest distance from the first internal electrode layer to the first lateral surface.

7. The multilayer ceramic capacitor according to claim 1, wherein a dimension of the multilayer body in the length direction is between about 0.7 mm and about 3.3 mm inclusive, a dimension of the multilayer body in the width direction is between about 0.3 mm and about 1.4 mm inclusive, and a dimension of the multilayer body in the lamination direction is, between about 0.2 mm and about 0.7 mm inclusive.

8. The multilayer ceramic capacitor according to claim 1, wherein the plurality of dielectric layers include BaTiO₃, CaTiO₃, SrTiO₃, or CaZrO₃.

9. The multilayer ceramic capacitor according to claim 1, wherein a thickness of each of the plurality of dielectric layers is between about 0.7 μm and about 1.3 μm inclusive.

10. The multilayer ceramic capacitor according to claim 1, wherein each of the plurality of internal electrode layers includes at least one of Ni, Cu, Ag, Pd, or Au, or an alloy including Ni, Cu, Ag, Pd, or Au.

11. The multilayer ceramic capacitor according to claim 1, wherein a thickness of each of the plurality of internal electrode layers is between about 0.3 μm and about 0.6 μm inclusive.

12. The multilayer ceramic capacitor according to claim 1, wherein a dimension of the first dummy electrode in the length direction is about 50% or more of an overall dimension of the multilayer body in the length direction.

13. The multilayer ceramic capacitor according to claim 3, wherein the main component of the first internal electrode is Ni.

14. The multilayer ceramic capacitor according to claim 2, wherein a main component of the second dummy electrode is the same as a main component of the second internal electrode layer.

15. The multilayer ceramic capacitor according to claim 14, wherein the main component of the second internal electrode layer is Ni.

16. The multilayer ceramic capacitor according to claim 2, wherein a distance between the second dummy electrode and a closer one of the first lateral surface and the second lateral surface is about 1 μm or more; and
a shortest distance between the second dummy electrode and the second internal electrode layer is about 1 μm or more.

17. The multilayer ceramic capacitor according to claim 2, wherein a thickness of the second dummy electrode in the lamination direction is between about 83% and about 120% inclusive of a thickness of the second internal electrode layer in the lamination direction.

18. The multilayer ceramic capacitor according to claim 1, wherein each of the first, second, third, and fourth external electrode layers includes a base electrode layer including at least one of a fired layer, an electrically conductive resin layer, or a thin film layer.

19. The multilayer ceramic capacitor according to claim 18, wherein each of the first, second, third, and fourth external electrode layers includes a plated layer on the base electrode layer.

20. The multilayer ceramic capacitor according to claim 19, wherein each of the plated layers includes a Ni plated layer and an Sn plated layer on the Ni plated layer.
